(19) United States
(12) Patent Application Publication
(10) Pub. No.: US 2018/0242384 A1
(43) Pub. Date: Aug. 23, 2018

(54) BANDWIDTH AGGREGATION FOR WIRELESS LOCAL AREA NETWORKS

(71) Applicant: QUALCOMM Incorporated, San Diego, CA (US)

(72) Inventors: Bin Tian, San Diego, CA (US); Sameer Vermani, San Diego, CA (US)

(21) Appl. No.: 15/893,477

(22) Filed: Feb. 9, 2018

Related U.S. Application Data
(60) Provisional application No. 62/460,422, filed on Feb. 17, 2017.

(51) Int. Cl. H04W 76/15; H04W 24/02; H04W 74/08

(52) U.S. Cl. CPC H04W 76/15; H04W 84/12; H04W 74/0808; H04W 24/02

(57) ABSTRACT

Methods, systems, and devices for wireless communication are described that provide for bandwidth aggregation for wireless local area network (WLAN) systems. A first device may monitor multiple anchor channels of at least one radio frequency (RF) spectrum band, and receive, from another device, a bandwidth aggregation indication on an anchor channel of the monitored plurality of anchor channels. The first device may then identify based on the received bandwidth aggregation indication, a bandwidth aggregation configuration including a first and second portion of the at least one RF spectrum band to use to receive communications from the other device. A transmitting device may select one of multiple anchor channels, transmit the indication of the bandwidth aggregation configuration to another device using the anchor channel, then transmit communications using the bandwidth aggregation configuration.

### CROSS REFERENCES

The present Application for Patent claims priority to U.S. Provisional Patent Application No. 62/460,422 by Tian, et al., entitled “Bandwidth Aggregation For Wireless Local Area Networks,” filed Feb. 17, 2017, assigned to the assignee hereof, and expressly incorporated by reference herein.

### BACKGROUND

The present disclosure, for example, relates to wireless communication systems, and more particularly to bandwidth aggregation for wireless local area network (WLAN) systems.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the STA, and the uplink (or reverse link) may refer to the communication link from the STA to the AP.

Devices in a WLAN may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands. The wireless connection between an AP and STA may be referred to as a channel or link. Users may access these radio frequency spectrum bands using various contention-based protocols (e.g., as specified by one or more versions of IEEE 802.11). Different bands (e.g., the 2.4 GHz band or the 5 GHz band) may contain multiple channels, each of which may be usable by an AP or STA. A channel may support multiple connections (e.g., between multiple STAs and the AP) in a multiple access configuration (e.g., code division multiple access (CDMA)). In some cases, the WLAN may have restrictions on how channels may be allocated, limiting flexibility of the system. These restrictions may be associated with decreased throughput for the system (e.g., because resources may go unused). Improved methods for allocating bandwidth for WLAN systems may thus be desired.

### SUMMARY

The described techniques relate to improved methods, systems, devices, or apparatuses that support bandwidth aggregation for wireless local area network (WLAN) systems. Within a WLAN system, an access point (AP) may communicate with one or more stations (STAs) as part of a basic service set (BSS), or a number of STAs may communicate with each other without an AP (e.g., in an ad-hoc network). The channels of one or more radio frequency (RF) spectrum bands may be aggregated into an aggregated channel by an AP to carry transmissions to or from a STA. The aggregated channel may include two or more sets of channels, where at least one set of channels may be discontiguous from the other sets of channels. The aggregated channel may include an anchor channel as part of one of the sets of channels. In other aggregation configurations, the aggregated channel may include two or more anchor channels. One or more anchor channels controlling access for an aggregated channel may fall outside a bandwidth of the aggregated channel. The aggregation configuration of the aggregated channel, including an identification of the channels that have been aggregated, may be indicated in the anchor channel (or each of the anchor channels, as applicable) as a bandwidth aggregation indication. An AP transmitting the indication of the aggregated configuration in one or more anchor channels may follow the indication in the anchor channel with transmissions to the indicated STA(s) using the aggregated channel.

One or more STAs of the WLAN may monitor a plurality of anchor channels within at least one RF spectrum band. A given STA may receive, on an anchor channel, an indication that information included in the anchor channel is for the STA and use the included information to identify a bandwidth aggregation configuration that the STA is to use to receive transmissions from the AP or transmit information to the AP. The bandwidth aggregation configuration may include multiple discontiguous (e.g., separated in frequency) portions of the at least one RF spectrum band. The bandwidth aggregation configuration for the STA may be varied over time, such that different transmissions from the AP to the same STA may be assigned different bandwidth aggregation configurations by the AP. Transmissions may be received concurrently from the AP over the multiple portions of the at least one RF spectrum band. The transmissions may be coordinated at the physical (PHY) or media access control (MAC) layer to reduce interference between neighboring (or nearby) frequencies in the at least one RF spectrum band.

A method of wireless communication is described. The method may include monitoring a plurality of anchor channels of at least one RF spectrum band, receiving, from a second wireless device on a first anchor channel of the monitored plurality of anchor channels, a bandwidth aggregation indication for the first wireless device, and identifying, based at least in part on the received bandwidth aggregation indication, a bandwidth aggregation configuration for the first wireless device, the bandwidth aggregation configuration including a first portion of the at least one RF spectrum band and a second portion of the at least one RF spectrum band for the first wireless device to use to receive communications from the second wireless device, the first portion of the at least one RF spectrum band being discontiguous in frequency with the second portion of the at least one RF spectrum band.

An apparatus for wireless communication is described. The apparatus may include means for monitoring a plurality of anchor channels of at least one RF spectrum band, means for receiving, from a wireless device on a first anchor channel of the monitored plurality of anchor channels, a bandwidth aggregation indication for the apparatus, and means for identifying, based at least in part on the received bandwidth aggregation indication, a bandwidth aggregation configuration for the apparatus, the bandwidth aggregation configuration including a first portion of the at least one RF spectrum band and a second portion of the at least one RF spectrum band for the first wireless device to use to receive communications from the second wireless device, the first portion of the at least one RF spectrum band being discontiguous in frequency with the second portion of the at least one RF spectrum band.

Another apparatus for wireless communication is described. The apparatus may include a processor, memory in electronic communication with the processor, and instructions stored in the memory. The instructions may be operable to cause the processor to monitor a plurality of anchor channels of at least one RF spectrum band, receive, from a wireless device on a first anchor channel of the monitored plurality of anchor channels, a bandwidth aggregation indication for the apparatus, and identify, based at least in part on the received bandwidth aggregation indication, a bandwidth aggregation configuration for the apparatus, the bandwidth aggregation configuration including a first portion of the at least one RF spectrum band and a second portion of the at least one RF spectrum band for the first wireless device to use to receive communications from the second wireless device, the first portion of the at least one RF spectrum band being discontiguous in frequency with the second portion of the at least one RF spectrum band.

A non-transitory computer-readable medium for wireless communication is described. The non-transitory computer-readable medium may include instructions operable to cause a processor to monitor a plurality of anchor channels of at least one RF spectrum band, receive, from a second wireless device on a first anchor channel of the monitored plurality of anchor channels, a bandwidth aggregation indication for the first wireless device, and identify, based at least in part on the received bandwidth aggregation indication, a bandwidth aggregation configuration for the first wireless device, the bandwidth aggregation configuration including a first portion of the at least one RF spectrum band and a second portion of the at least one RF spectrum band for the first wireless device to use to receive communications from the second wireless device, the first portion of the at least one RF spectrum band being discontiguous in frequency with the second portion of the at least one RF spectrum band.

Some examples of the method, apparatus, and non-transitory computer-readable medium described above may further include processes, features, means, or instructions for receiving a first portion of the communications on the first portion of the at least one RF spectrum band and a second portion of the communications on the second portion of the at least one RF spectrum band based at least in part on the identified bandwidth aggregation configuration, both the first portion of the communications and the second portion of the communications received starting at a first time and ending at a second time.

Some examples of the method, apparatus, and non-transitory computer-readable medium described above may further include processes, features, means, or instructions for receiving, from an access point, an indication of an anchor channel configuration that identifies the plurality of anchor channels of the at least one RF spectrum band, wherein the access point is the wireless device or a second wireless device.

Some examples of the method, apparatus, and non-transitory computer-readable medium described above may further include processes, features, means, or instructions for transmitting an indication of an anchor channel configuration that identifies the plurality of anchor channels of the at least one RF spectrum band.

Some examples of the method, apparatus, and non-transitory computer-readable medium described above may further include processes, features, means, or instructions for receiving a first portion of the communications from a first radio of the wireless device on the first portion of the at least one RF spectrum band and receiving a second portion of the communications from a second radio of the wireless device on the second portion of the at least one RF spectrum band.

Some examples of the method, apparatus, and non-transitory computer-readable medium described above may further include processes, features, means, or instructions for receiving the bandwidth aggregation indication in a wireless local area networking (WLAN) control frame or a preamble of a WLAN data frame.

In some examples of the method, apparatus, and non-transitory computer-readable medium described above, the first anchor channel is outside the first portion of the at least one RF spectrum band and the second portion of the at least one RF spectrum band.

In some examples of the method, apparatus, and non-transitory computer-readable medium described above, the plurality of anchor channels are evenly distributed in the at least one RF spectrum band.

In some examples of the method, apparatus, and non-transitory computer-readable medium described above, the first portion of the at least one RF spectrum band is separated in frequency from the second portion of the at least one RF spectrum band by less than 160 MHz.

Some examples of the method, apparatus, and non-transitory computer-readable medium described above may further include processes, features, means, or instructions for receiving a first portion of the communications on the first portion of the at least one RF spectrum band and a second portion of the communications on the second portion of the at least one RF spectrum band based at least in part on the identified bandwidth aggregation configuration, the first portion of the communications received at least partially concurrently with the second portion of the communications.

Some examples of the method, apparatus, and non-transitory computer-readable medium described above may further include processes, features, means, or instructions for monitoring the first anchor channel of the plurality of anchor channels, the first anchor channel controlling channel access for a first set of channels of the at least one RF spectrum band and monitoring a second anchor channel of the plurality of anchor channels, the second anchor channel controlling channel access for a second set of channels of the at least one RF spectrum band, wherein at least one of the first set of channels is a same channel as at least one of the second set of channels.

In some examples of the method, apparatus, and non-transitory computer-readable medium described above, the at least one RF spectrum band comprises a first RF spectrum band and a second RF spectrum band, the first anchor channel is in the first RF spectrum band, and a second anchor channel of the plurality of anchor channels is in the second RF spectrum band.

A method of wireless communication is described. The method may include selecting a first anchor channel of a plurality of anchor channels of at least one RF spectrum band, transmitting, to a second wireless device on the selected first anchor channel, a bandwidth aggregation indication for the second wireless device, transmitting, to the second wireless device, a first portion of communications on a first portion of the at least one RF spectrum band identified by the bandwidth aggregation indication, and transmitting, to the second wireless device, a second portion of the communications on a second portion of the at least one RF spectrum band identified by the bandwidth aggregation indication, the first portion of the RF spectrum band being discontiguous in frequency with the second portion of the RF spectrum band.

An apparatus for wireless communication is described. The apparatus may include means for selecting a first anchor channel of a plurality of anchor channels of at least one RF spectrum band, means for transmitting, to a second wireless device on the selected first anchor channel, a bandwidth aggregation indication for the second wireless device, means for transmitting, to the second wireless device, a first portion of communications on a first portion of the at least one RF spectrum band identified by the bandwidth aggregation indication, and means for transmitting, to the second wireless device, a second portion of the communications on a second portion of the at least one RF spectrum band identified by the bandwidth aggregation indication, the first portion of the RF spectrum band being discontiguous in frequency with the second portion of the RF spectrum band.

Another apparatus for wireless communication is described. The apparatus may include a processor, memory in electronic communication with the processor, and instructions stored in the memory. The instructions may be operable to cause the processor to select a first anchor channel of a plurality of anchor channels of at least one RF spectrum band, transmit, to a second wireless device on the selected first anchor channel, a bandwidth aggregation indication for the second wireless device, transmit, to the second wireless device, a first portion of communications on a first portion of the at least one RF spectrum band identified by the bandwidth aggregation indication, and transmit, to the second wireless device, a second portion of the communications on a second portion of the at least one RF spectrum band identified by the bandwidth aggregation indication, the first portion of the RF spectrum band being discontiguous in frequency with the second portion of the RF spectrum band.

A non-transitory computer-readable medium for wireless communication is described. The non-transitory computer-readable medium may include instructions operable to cause a processor to select a first anchor channel of a plurality of anchor channels of at least one RF spectrum band, transmit, to a second wireless device on the selected first anchor channel, a bandwidth aggregation indication for the second wireless device, transmit, to the second wireless device, a first portion of communications on a first portion of the at least one RF spectrum band identified by the bandwidth aggregation indication, and transmit, to the second wireless device, a second portion of the communications on a second portion of the at least one RF spectrum band identified by the bandwidth aggregation indication, the first portion of the RF spectrum band being discontiguous in frequency with the second portion of the RF spectrum band.

Some examples of the method, apparatus, and non-transitory computer-readable medium described above may further include processes, features, means, or instructions for transmitting an indication of an anchor channel configuration that identifies the plurality of anchor channels of the at least one RF spectrum band.

Some examples of the method, apparatus, and non-transitory computer-readable medium described above may further include processes, features, means, or instructions for receiving, from an access point, an indication of an anchor channel configuration that identifies the plurality of anchor channels of the at least one RF spectrum band, wherein the access point is the wireless device or a second wireless device

Some examples of the method, apparatus, and non-transitory computer-readable medium described above may further include processes, features, means, or instructions for determining an amount of the communications to be transmitted to the second wireless device. Some examples of the method, apparatus, and non-transitory computer-readable medium described above may further include processes, features, means, or instructions for selecting the first portion and the second portion of the at least one RF spectrum band to use to transmit the communications based at least in part on the determination.

Some examples of the method, apparatus, and non-transitory computer-readable medium described above may further include processes, features, means, or instructions for performing a first CCA for a second anchor channel of the plurality of anchor channels, wherein the CCA indicates that the second anchor channel is occupied. Some examples of the method, apparatus, and non-transitory computer-readable medium described above may further include processes, features, means, or instructions for performing a second CCA for the first anchor channel, wherein the second CCA indicates that the first anchor channel is unoccupied. Some examples of the method, apparatus, and non-transitory computer-readable medium described above may further include processes, features, means, or instructions for selecting the first portion and the second portion of the at least one RF spectrum band to use to transmit the communications based at least in part on the second CCA indicating that the first anchor channel is unoccupied.

Some examples of the method, apparatus, and non-transitory computer-readable medium described above may further include processes, features, means, or instructions for performing, based at least in part on the second CCA indicating that the first anchor channel is unoccupied, a third CCA for at least one secondary channel associated with the first anchor channel, the second anchor channel, or both.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a system for wireless communication that supports bandwidth aggregation for WLAN systems in accordance with various aspects of the present disclosure;

FIG. 2 shows an example of a system for wireless communication that supports bandwidth aggregation for WLAN systems in accordance with various aspects of the present disclosure;

FIG. 3 shows a block diagram of example frequency spectrum allocations that supports bandwidth aggregation for WLAN systems in accordance with various aspects of the present disclosure;

FIGS. 4 through 6 show block diagrams of a device that supports bandwidth aggregation for WLAN systems in accordance with aspects of the present disclosure;

FIG. 7 illustrates a block diagram of a system including a STA that supports bandwidth aggregation for WLAN systems in accordance with aspects of the present disclosure;

FIGS. 8 through 10 show block diagrams of a device that supports bandwidth aggregation for WLAN systems in accordance with aspects of the present disclosure;

FIG. 11 illustrates a block diagram of a system including an AP that supports bandwidth aggregation for WLAN systems in accordance with aspects of the present disclosure; and

FIGS. 12 through 15 illustrate methods for bandwidth aggregation for WLAN systems in accordance with aspects of the present disclosure.

### DETAILED DESCRIPTION

The described techniques relate to improved methods, systems, devices, or apparatuses that support bandwidth aggregation for wireless local area networks (WLANs).

The described techniques relate to improved methods, systems, devices, or apparatuses that support bandwidth aggregation for WLANs. Within a WLAN, an access point (AP) may communicate with one or more stations (STAs) or mobile devices. Additionally, STAs may communicate with each other (e.g., in an ad-hoc network). These communications may occur over unlicensed or shared radio frequency spectrum bands, which may contain multiple channels. In some applications (e.g., in IEEE 802.11ac and 802.11ax WLAN systems), channel aggregation (e.g., within the same radio frequency (RF) band or across separate RF bands) may be possible. However, these systems may impose restrictions on how aggregation is implemented (e.g., to simplify aggregation implementation). The restrictions may limit the flexibility of resource allocations within the system, which may in turn decrease throughput for the system. Improved methods for bandwidth aggregation may thus be desired.

In accordance with aspects of the present disclosure, various bandwidth aggregation schemes may be improved to enhance system performance. That is, the present disclosure describes techniques enabling flexible bandwidth allocation, which may in turn improve the WLAN system throughput. In aspects of the present disclosure, the flexible allocation may include dynamically updating bandwidth aggregation configurations, relaxing restrictions on the aggregation configurations themselves, and improving signaling techniques to enable these features.

Communications within a WLAN system may occur over unlicensed RF spectrum bands, each of which may contain multiple channels. In some cases (e.g., in IEEE 802.11ac and 802.11ax capable devices), channel aggregation may be possible. Channel aggregation provides wider bandwidths and corresponding increases in data rates. Due to regulatory constraints on spectrum availability and the overlapping nature of channels in these systems, channel aggregation may be implemented with some restrictions. In some cases, these restrictions may limit the throughput of the system such that the increase in data rate because of the increased bandwidth may be somewhat mitigated. Improved methods for bandwidth aggregation for WLAN systems may thus be desired.

WLAN systems supporting versions of IEEE 802.11 up to and including 802.11ax may support aggregated bandwidths up to 160 MHz (e.g., aggregation of two 80 MHz channels). In some cases, aggregated channels of 40 MHz, 80 MHz, and 160 MHz may be formed by combining an appropriate number of 20 MHz sub-channels in a non-overlapping manner. In some cases, devices may be operable to avoid transmitting over the same set of resources using various clear channel assessment (CCA) techniques. However, these CCA techniques may in some cases be performed only on a primary 20 MHz portion of the aggregated channel, such that a device may refrain from transmitting if it detects a transmission in the primary channel (even if other portions of the aggregated bandwidth are not being used). Such a scenario illustrates an example of how the restrictions associated with aggregation implementation may limit throughput for the system. Other examples are described below. Techniques described herein enable flexible bandwidth aggregation and dynamic updating of aggregation configurations (e.g., on a packet-by-packet basis) to address these issues.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Aspects of the disclosure are initially described in the context of a wireless communications system. Examples of wireless systems supporting bandwidth aggregation for WLANs are then described. Aspects of the disclosure are further illustrated by and described with reference to apparatus diagrams, system diagrams, and flowcharts that relate to bandwidth aggregation for WLANs.

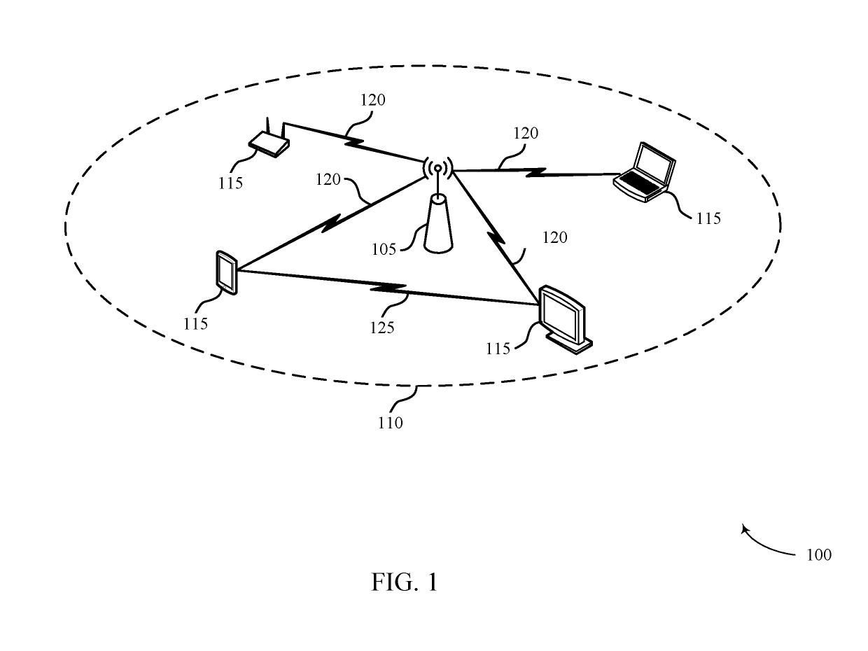

FIG. 1 illustrates a WLAN 100 (also known as a Wi-Fi network) configured in accordance with various aspects of the present disclosure. The WLAN 100 may include an AP 105 and multiple associated STAs 115 (each of which may be referred to as a wireless device herein), which may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS.

Some types of wireless devices may provide for automated communication. Automated wireless devices may include those implementing internet-of-things (IoT) communication, Machine-to-Machine (M2M) communication, or machine type communication (MTC). IoT, M2M, or MTC may refer to data communication technologies that allow devices to communicate with one another or a base station without human intervention. For example, IoT, M2M, or MTC may refer to communications from devices that integrate sensors or meters to measure or capture information and relay that information to a central server or application program that can make use of the information or present the information to humans interacting with the program or application.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections.

The STAs 115 may be designed to allow a user to send and receive data to and from various networks and entities (e.g., AP 105 or another STA 115). In some cases, a wireless device (e.g., STA 115 or AP 105) may operate in a low-power mode (e.g., to conserve a limited amount of battery power) by powering down or off all or portions of one or memory units or processors, or other components of the wireless device. The wireless device may also reduce the frequency of certain operations, including network communications, memory accesses or updates, or other background processes.

STAs 115 and AP 105 may communicate (e.g., via bidirectional communication link 120) according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11ba, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band (including the low 5 GHz band and the high 5 GHz band), the 2.4 GHz band, the 60 GHz band, the 3.6 GHz band, and/or the 900 MHz band. The unlicensed spectrum may also include other frequency bands. Users may access these radio frequency spectrum bands using various contention-based protocols (e.g., as specified by one or more versions of IEEE 802.11).

There may be cases in a WLAN 100 in which bidirectional communication link 120 occurs over an aggregated bandwidth, including channels from one or more portions of spectrum, which portions may be non-contiguous in frequency. The STA 115 may use various contention-based protocols (e.g., listen-before-talk (LBT)) on the anchor channel of its associated BSS to determine the availability of the aggregated channel (or several different aggregated channels). That is, the STA 115 may share some or all of the aggregated bandwidth with other STAs 115 (e.g., which may be part of the same BSS or a different BSS) and accordingly sense the medium to detect transmissions before itself transmitting (e.g., to avoid packet collisions). However, in some cases the anchor channel may be busy while one or more other channels within the aggregated bandwidth may be idle. Techniques for allocating these unused channels to STAs 115 that would otherwise be unable to access these channels may improve throughput for WLAN 100 (e.g., or provide other similar benefits).

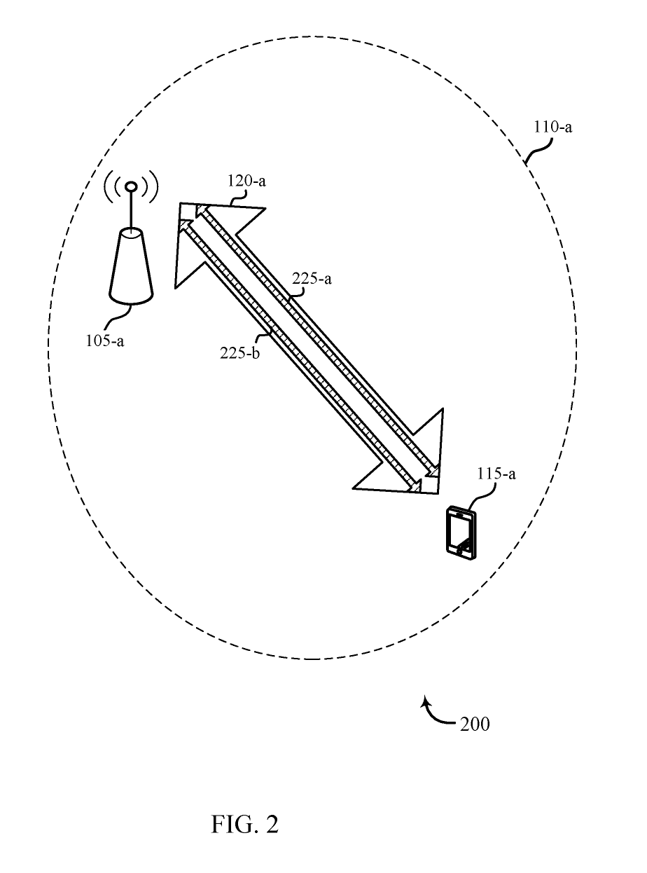

FIG. 2 illustrates an example of a wireless communications system 200 (e.g., a WLAN) that supports bandwidth aggregation for WLAN systems in accordance with aspects of the present disclosure. Wireless communications system 200 may include STA 115-a and AP 105-a, which may be examples of a STA 115 and an AP 105 described with reference to FIG. 1. STA 115-a and AP 105-a may be operable to communicate over a bidirectional communication link 120-a, which may be an example of the corresponding link described with reference to FIG. 1. Though communication in the present example is described as occurring between a STA 115 and an AP 105, communication between two STAs 115 is equally possible using the techniques described herein. In some cases, bidirectional communication link 120-a may occur over an aggregation of multiple (e.g., two as shown in the present example) channels 225-a and 225-b. As an example, each channel 225-a and 225-b may have a bandwidth of 80 MHz such that the total bandwidth for bidirectional communication link 120-a may be 160 MHz. This wider bandwidth may enable a higher throughput for bidirectional communication link 120-a (e.g., as compared to throughput achieved over a single 80 MHz channel). Alternative bandwidths for channel 225-a and channel 225-b are considered. For example, channel 225-a may have a bandwidth of 40 MHz while channel 225-b may have a bandwidth of 20 MHz such that the total bandwidth for bidirectional communication link 120-a may be 60 MHz.

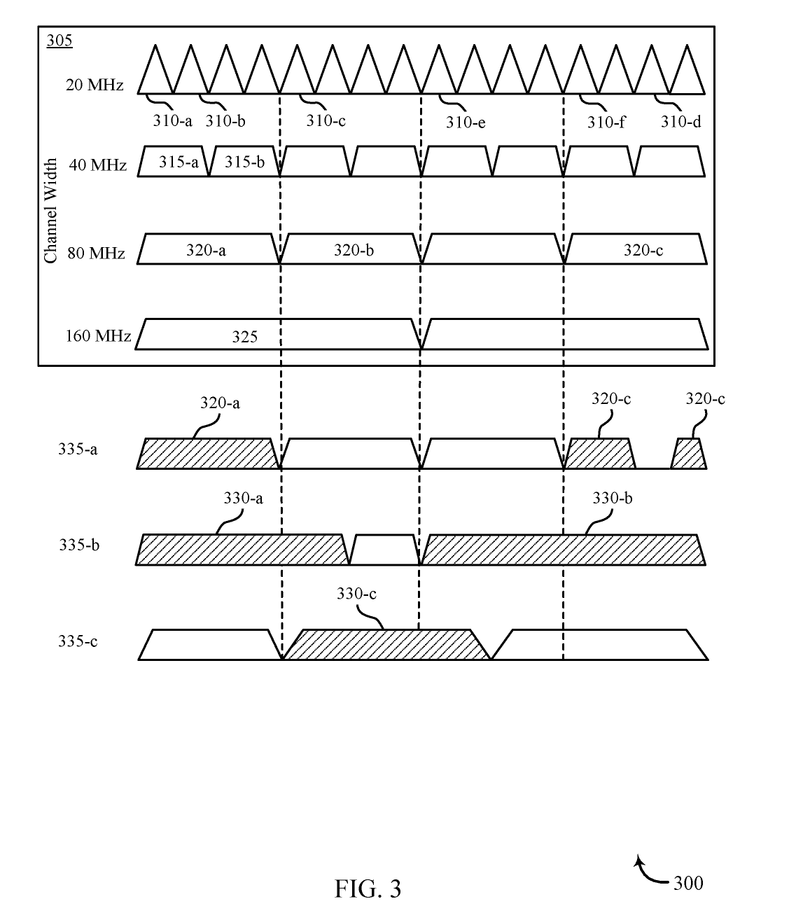

Aspects of the following channel aggregation descriptions may be better understood with reference to box 305 of FIG. 3. WLANs operating according to different versions of IEEE 802.11 (e.g., 802.11n devices) may be operable to bond two adjacent 20 MHz channels (e.g., an anchor channel and a non-anchor channel immediately above or below the anchor channel in the frequency spectrum) to form a 40 MHz channel. As used herein, an anchor channel may refer to a channel (e.g., a 20 MHz channel) over which an AP 105 transmits (e.g., broadcasts) management information for a given BSS in addition to data. For example, all channel access timing in the BSS may be based on a CCA of the anchor channel. Accordingly, an AP 105 supporting multiple BSSs may be configured to support multiple anchor channels (e.g., one or more for each BSS). Correspondingly, a STA 115 that has associated with one or more BSSs may be operable to monitor multiple anchor channels. In some cases, neighboring BSSs may use different primary 20 MHz channels, but may overlap on some or all of the 20 MHz non-primary channels they occupy. Accordingly, before transmitting, a STA 115 or AP 105 may check that its transmission on the wireless medium will not interfere with traffic on a secondary channel that may be shared between multiple BSSs. In some cases, a device may detect a transmission on a secondary channel and transmit on its anchor channel without transmitting on the secondary channel. Additionally or alternatively, having detected traffic on the secondary channel, the device may restart its backoff procedure and sense the medium at some later point in time.

WLANs operating according to different versions of IEEE 802.11 (e.g., 802.11ac or 802.11ax capable devices) may be further operable to bond two adjacent 40 MHz channels to form an 80 MHz channel. One of the 40 MHz channels may contain the 20 MHz anchor channel and be referred to as the primary 40 MHz channel. In some cases, the secondary 40 MHz channel may contain an anchor channel for a second BSS (e.g., which may be associated with the same AP 105 or with a different AP 105). As described above, before transmitting across the entire 80 MHz bandwidth, a STA 115 or AP 105 may check that its transmission will not interfere with traffic on a secondary 40 MHz channel. In some cases, a device may detect a transmission on the secondary channel and subsequently fall back to transmitting on its primary 40 MHz channel.

Some wireless devices (e.g., 802.11ac and 802.11ax devices) may be further operable to bond two 80 MHz channels (e.g., which may be contiguous or non-contiguous in frequency) to form a 160 MHz channel. In some systems, the bonding of non-contiguous 80 MHz channels may be referred to as an “80+80 MHz mode.” Communication in the 80+80 MHz mode may require a device to have twice as many receive chains (e.g., because the 160 MHz transmission may be transmitted in two separate 80 MHz segments). As for the 80 MHz transmissions, the 160 MHz mode and the 80+80 MHz mode may employ a primary 80 MHz channel (e.g., which contains the anchor channel) and a secondary 80 MHz channel. A CCA may be performed independently for each 80 MHz channel. However, even in the case that the secondary 80 MHz channel is idle, a device (e.g., a STA or AP) may not transmit (e.g., because some systems may operate according to a restriction that all transmissions within a given BSS must occupy the anchor channel). Wider bandwidths may increase the data rate for wireless communications system 200. However, the increased data rate may come at the cost of increased system complexity (e.g., because of the possibility of overlapping transmissions of different BSSs). Aspects of the following provide benefits to wireless communications system 200 (e.g., by addressing the increased system complexity associated with bandwidth aggregation). A transmitting device (e.g., AP 105-a or STA 115-a) may determine an availability of channel 225-a (e.g., based at least in part on a CCA of an anchor channel associated with channel 225-a). Upon determining that channel 225-a is available, the transmitting device may determine an availability of channel 225-b (e.g., based at least in part on a CCA of an anchor channel associated with channel 225-b and/or one or more secondary channels associated with channel 225-b). The transmitting device may then transmit a communication across the aggregable (e.g., unoccupied) portions of channel 225-a and channel 225-b.

FIG. 3 illustrates an example channel aggregation scheme 300 that supports bandwidth aggregation for WLAN systems in accordance with aspects of the present disclosure. Channel aggregation scheme 300 may represent bandwidth allocations for communications between an AP 105 and a STA 115, two STAs 115, etc., each of which may be an example of the corresponding device described with reference to FIGS. 1 and 2.

Aspects of channel aggregation scheme 300 may be described with reference to the channel hierarchy displayed in box 305. The top row of box 305 illustrates sixteen 20 MHz channels 310, each of which may contain a set of subcarriers (e.g., sixty-four orthogonal subcarriers). Each subcarrier within a 20 MHz channel 310 may be modulated to transmit complementary information to that transmitted by the other subcarriers within its 20 MHz channel 310 (e.g., and any other channels with which it is aggregated). Before accessing a given channel, a wireless device may perform a CCA procedure to avoid packet collisions. When a STA 115 associates with an AP 105, the STA 115 may be assigned to one or more BSSs by the AP 105. Each BSS may have one or more primary 20 MHz channels 310 (e.g., a channel which conveys timing configuration information for the BSS). In aspects of the present disclosure, the term “anchor channel” may be used to refer to the primary 20 MHz channel 310.

In some cases, there may be more 20 MHz channels 310 in the WLAN system that overlap (e.g., at least partially) with the sixteen illustrated 20 MHz channels 310. However, channel aggregation (e.g., as described above with reference to FIG. 2) may be achieved by combining non-overlapping 20 MHz channels 310. In the subsequent examples, primary 20 MHz channel 310-a may represent an anchor channel for a given BSS. Primary 20 MHz channel 310-a may be aggregated with a secondary 20 MHz channel 310-b (e.g., or an analogous 20 MHz channel 310 located below primary 20 MHz channel 310-a in the frequency spectrum) to form a primary 40 MHz channel 315-a. Primary 40 MHz channel 315-a may in turn be combined with a secondary channel 40 MHz channel 315-b to form a primary 80 MHz channel 320-a. In some cases, primary 80 MHz channel 320-a may be combined with a secondary 80 MHz channel 320-b to form 160 MHz channel 325 (e.g., for transmissions in a 160 MHz mode). Alternatively, transmissions may use non-contiguous 80 MHz channels 320 (e.g., primary 80 MHz channel 320-a and secondary 80 MHz channel 320-c) in an 80+80 MHz mode. In another example, 20 MHz channel 310-c may represent an anchor channel for a second BSS and may be aggregated into secondary 80 MHz channel 320-b. In these examples, the terms primary and secondary are used from the perspective of a STA 115 associated with the BSS for which primary 20 MHz channel 310-a is the anchor channel. Accordingly, secondary 80 MHz channel 320-b may alternatively be referred to as a primary 80 MHz channel 320 for the second BSS (e.g., a BSS with 20 MHz channel 310-c as its anchor channel).

Channel aggregation configuration 335-a illustrates an example in which a device is operating in an 80+80 MHz mode. Channel aggregation configuration 335-a illustrates four 80 MHz channels 320 in a RF spectrum band (e.g., the 5 GHz band). It is to be understood that more or fewer 80 MHz channels 320 may be contained in the RF spectrum band, and that one or more of the 80 MHz channels 320 may alternatively be in a different RF spectrum band (e.g., the 2.4 GHz band). As described above, primary 20 MHz channel 310-a may be the anchor channel for its BSS. Accordingly, the configuration information (e.g., the supported aggregation configuration and location of the secondary channel(s)) for channel aggregation configuration 335-a may be conveyed in primary 20 MHz channel 310-a. Aspects of the present example are also applicable to operation in a 160 MHz transmission mode in which the two 80 MHz channels 320 are contiguous (e.g., primary channel 320-a and secondary channel 320-b in box 305) and the transmission is sent across the entire 160 MHz bandwidth (e.g., is not segmented into separate 80 MHz transmissions), as illustrated by 160 MHz channel 325.

Additionally or alternatively, channel aggregation configuration 335-a may illustrate aspects of a communication scheme employed by STAs 115 and/or APs 105 that are operable to communicate over multiple RF bands using multiple independent radios. By way of example, a STA 115 may communicate over 80 MHz channel 320-a in the 5 GHz high band using one radio and communicate over 80 MHz channel 320-c in the 5 GHz low band (e.g., or the 2.4 GHz band, etc.) using a second radio. In some examples, aggregation of these bands may be performed at an upper layer (e.g., without coordination among the transmissions over 80 MHz channels 320-a and 320-c at the media access control (MAC) or physical (PHY) layers). In some cases (e.g., to avoid or mitigate transmission interference), 80 MHz channels 320-a and 320-c may be separated in frequency to ensure RF isolation for the transmissions. As an example, some wireless communications systems may separate 80 MHz channels 320-a and 320-c to be at least 160 MHz apart (e.g., as illustrated in channel aggregation configuration 335-a). Such a band aggregation implementation using independent radios may not be compatible with a channel configuration having two adjacent channels (e.g., 80 MHz channels 320-a and 320-b).

In some cases, wireless devices (e.g., 802.11ax devices) may be operable to support preamble puncturing, e.g., which may allow one or more non-primary 20 MHz channels 310 to be punctured in a given transmission. Channel aggregation configuration 335-a illustrates an example in which a 20 MHz channel 310-d within 80 MHz channel 320-c has been punctured for a given transmission (e.g., such that a transmitting wireless device does not transmit over 20 MHz channel 310-d for this transmission). In some cases, the indication of which 20 MHz channel(s) 310 are (or will be) punctured may be contained in the preamble of a transmission in primary 20 MHz channel 310-a. There may be limitations on supported preamble puncturing patterns. As an example, a wireless device (e.g., a STA 115) may not be allowed to aggregate the bandwidth of its primary 20 MHz channel 310 with a secondary 80 MHz channel 320.

In some cases, a wireless communications system that uses the examples described above with reference to channel aggregation configuration 335-a may experience limitations. As an example, transmissions for a given BSS may have to occupy primary 20 MHz channel 310-a (e.g., since all channel access timing in the BSS is based on the CCA of the primary 20 MHz channel 310-a). Accordingly, if primary 20 MHz channel 310-a is busy (e.g., because another wireless device within the same BSS or another BSS is transmitting), a STA 115 may be prevented from transmitting even though one or more other 20 MHz channels 310 within 80 MHz channels 320-a and/or 320-b are idle.

As another example, aggregation described with reference to channel aggregation configuration 335-a may only occur up to 160 MHz or else within the 80 MHz overlapping basic service set (OB SS) bandwidth (e.g., within channel 320-a). Some flexibility in bandwidth allocation through the use of puncturing (e.g., transmitting on three of four 20 MHz channels 310 of an 80 MHz channel 320, wherein the fourth 20 MHz channel 310 of the 80 MHz channel 320 is occupied) may allow for bandwidths between 80 MHz and 160 MHz to be used. However, as discussed above, the puncturing patterns may in some cases themselves be subject to restrictions. Additionally, the punctured channels may in some cases go unused (e.g., because other wireless devices may be prohibited from transmitting while the primary 20 MHz channel 310-a is occupied).

To alleviate the various issues outlined above, a wireless communications system may benefit from different bandwidth aggregation techniques. In some examples, more flexible bandwidth aggregation may be enabled using multiple radios. Additionally or alternatively, such a flexible bandwidth aggregation scheme may include the use of multiple anchor channels (e.g., such that each BSS may provide multiple anchor channels accessible to devices of the BSS). Examples are discussed below with reference to example channel aggregation configurations 335-b and 335-c.

Channel aggregation configuration 335-b illustrates an example of bandwidth aggregation. In the present example, a device such as a STA 115 or an AP 105 may use a first radio to transmit on channel 330-a and a second radio to transmit on channel 330-b. In this example, channel 330-a has a bandwidth of 120 MHz and channel 330-b has a bandwidth of 160 MHz (such that the aggregated bandwidth is 280 MHz). Although this example is described with two channels 330 aggregated together, it is to be understood that more than two channels 330 may be aggregated using the techniques described below. In some examples, a transmitting device (e.g., a STA 115) may transmit over each channel to be aggregated (e.g., a 40 MHz channel 315, a 80 MHz channel 320, and a 160 MHz channel 325 comprising an aggregated 280 MHz channel) using separate radios. The bandwidths of channels 330-a and 330-b may be flexible (e.g., may be any multiple of 20 MHz). Furthermore, the transmissions over channels 330-a and 330-b may be coordinated such that no guard bandwidth may be necessary to ensure RF isolation between the transmissions. That is, in some examples, channel aggregation (e.g., transmission coordination) may occur at the PHY and/or MAC layer such that the need for RF isolation by using guard bandwidths may be obviated.

In some cases, the channel aggregation configuration 335 may be dynamically adjusted (e.g., may be changed from packet to packet based on channel availability and/or an amount of data to be sent). As an example, channel aggregation configuration 335-b may be employed for a first packet, and channel aggregation configuration 335-c may be employed for a subsequent packet between a same set of communicating devices. In channel aggregation configuration 335-c, the first radio may communicate on channel 330-c, which is displayed with an example bandwidth of 100 MHz.

In some cases, a wireless communications system may be configured to assign an anchor channel for a given portion of available spectrum (e.g., a single anchor channel for every 80 MHz of the available spectrum, one anchor channel for every 160 MHz of available spectrum, etc.). In some examples, the anchor channels may be evenly distributed in the spectrum. For example, the first 20 MHz channel 310 of each set of four non-overlapping 20 MHz channels 310 may be assigned to be an anchor channel. For example 20 MHz channels 310-a, 310-c, 310-e, 310-f, etc., may each be anchor channels. In other examples, the anchor channels may be distributed according to another arrangement. For example, the anchor channels may be concentrated around a lower bandwidth of the RF spectrum, may occur more frequently in an upper bandwidth of the RF spectrum, etc. In some examples, an AP 105 may notify each of the STAs 115 of the BSS for the AP 105 of the frequency locations of each of the anchor channels during an association and authentication procedure. Thus, the anchor channel distribution may be known to the STAs 115, and these STAs 115 may monitor such anchor channels. In some examples, AP 105 may periodically or aperiodically update the anchor channel locations and transmit an update to STAs 115. Accordingly, an AP 105 may assign multiple anchor channels for a single BSS.

In some examples, transmission may be allowed if one or more of the anchor channels is idle. For example, with reference to channel aggregation configuration 335-b, a transmitting device (e.g., a STA 115) may access channel 330-a based at least in part on a CCA of anchor 20 MHz channel 310-a. For the present example, 20 MHz channel 310-f may represent another anchor channel, and the transmitting device may access channel 330-b based at least in part on a CCA of anchor 20 MHz channel 310-f.

That is, a transmitting device (e.g., a STA 115 or an AP 105) may independently perform respective CCAs on a plurality of anchor channels and may transmit across an aggregated bandwidth (e.g., channel 330-a, channel 330-b, portions thereof) based on at least one of the CCAs succeeding. By way of example, the transmitting device may attempt to access channel 330-a based on a CCA of anchor 20 MHz channel 310-a but may detect a transmission on anchor 20 MHz channel 310-a. The transmitting device may thus start a backoff timer corresponding to a backoff period and associated with the CCA of anchor 20 MHz channel 310-a. In accordance with the described techniques, the transmitting device may independently (e.g., without considering the backoff timer associated with the CCA of anchor 20 MHz channel 310-a) perform a CCA for anchor 20 MHz channel 310-f Upon detecting a clear anchor 20 MHz channel 310, the transmitting device may determine an aggregable channel bandwidth for channel 330-b. For example, the transmitting device may identify a set of available secondary 20 MHz channels 310 based on respective CCAs performed on some (or all) of the secondary 20 MHz channels 310 associated with anchor 20 MHz channel 310-f. Upon identifying an available bandwidth (e.g., represented by a bandwidth of channel 330-b), the device may begin transmitting to another device. In some cases, the transmitting device may (upon successfully performing the CCA for anchor 20 MHz channel 310-f) re-initiate the CCA for anchor 20 MHz channel 310-a (e.g., regardless of whether the backoff timer has expired, for example at the end of a backoff period). In the case that the second CCA for anchor 20 MHz channel 310-a succeeds, the transmitting device may in some cases simultaneously begin transmitting across channel 330-a and channel 330-b.

The transmitting device may indicate (e.g., via anchor 20 MHz channel 310-f) a bandwidth aggregation configuration to be used for the transmission. In some cases, the bandwidth aggregation configuration may indicate a bandwidth of channel 330-b, a duration of the transmission, etc. In some cases, the bandwidth of channel 330-b may depend on one or more CCAs for other anchor 20 MHz channels 310 (e.g., 20 MHz channel 310-e, which may be an anchor channel for another BSS). That is, in some cases the aggregated bandwidth may depend on one or more CCAs, each CCA performed for a respective anchor 20 MHz channel 310 and one or more secondary channels associated with the anchor channel 310. That is, whether a transmission is allowed or not may depend on the CCA results of an anchor 20 MHz channel 310 (e.g., or an anchor channel having a bandwidth different from 20 MHz). The aggregated bandwidth of the transmission (e.g., the bandwidth of channel 330-b) may depend on the CCA results for the anchor 20 MHz channel 310-f and one or more secondary 20 MHz channels 310. For example, some of the one or more secondary 20 MHz channels 310 may be associated with anchor 20 MHz channel 310-a while the rest of the secondary 20 MHz channels 310 may be associated with anchor 20 MHz channel 310-f. That is, upon detecting an idle anchor 20 MHz channel 310-f, a transmitting device may perform a CCA for some or all of the configured secondary 20 MHz channels 310 for both 20 MHz channel 310-a and 20 MHz channel 310-f to determine an aggregable bandwidth for a given transmission. That is, once the transmitting device detects an idle anchor channel (e.g., 20 MHz channel 310-f), it may check the secondary 20 MHz channels 310 for a set of anchor channels including the idle anchor channel (e.g., secondary 20 MHz channels 310 for both 20 MHz channel 310-a and 20 MHz channel 310-f) to determine an aggregable bandwidth. In some examples, a transmitting device may perform CCAs for multiple anchor 20 MHz channels 310 within the same BSS which have overlapping secondary 20 MHz channels 310. For example, the transmitting device may perform CCAs for anchor 20 MHz channel 310-f and anchor 20 MHz channel 310-d. If one of the anchor 20 MHz channels 310 is idle, the transmitting device may use all idle secondary channels within the BSS for transmission. In some cases, an AP 105 may determine the bandwidth aggregation configuration and may indicate the configuration to a STA 115. In various examples, the transmissions over the aggregated bandwidth may be uplink transmissions (e.g., from a STA 115 to an AP 105) or may be downlink transmissions (e.g., from an AP 105 to a STA 115), or a combination of uplink transmission and downlink transmissions.

At some subsequent time, the transmitting device may access channel 330-c based at least in part on a CCA of anchor 20 MHz channel 310-c. That is, in some examples, the transmitting device may flexibly select an anchor channel over which to initiate a CCA procedure based on the traffic load, energy constraints, regulatory restrictions, etc. Thus, where some systems may be restricted to communicating over the single anchor channel for its given BSS and any available aggregated channel associated with that anchor channel, a device operating in accordance with the present disclosure may dynamically select between a plurality of anchor carriers. The increase in anchor channels may translate to increased transmission opportunities (e.g., since it is less likely that all anchor channels will be busy at a single point in time). In some cases, aggregation may be performed across the idle channels associated with a given anchor channel. Accordingly, a transmitting device may be operable to aggregate punctured bandwidths that may otherwise be unavailable (e.g., without using the described techniques). In some cases, transmission preambles and/or separate control frames (e.g., trigger frames) may contain information regarding the size and location of the transmission blocks over multiple channels (e.g., channels 330-a and 330-b) to enable aggregation at the MAC and/or PHY layer (e.g., for channel aggregation configuration 335-b). In some example systems, the anchor channel configuration (e.g., location) of some or all anchor channels available for a given BSS may be transmitted in each anchor channel, such that a receiving device (e.g., a STA 115) may be informed of other anchor channels in use by the AP 105 of the BSS.

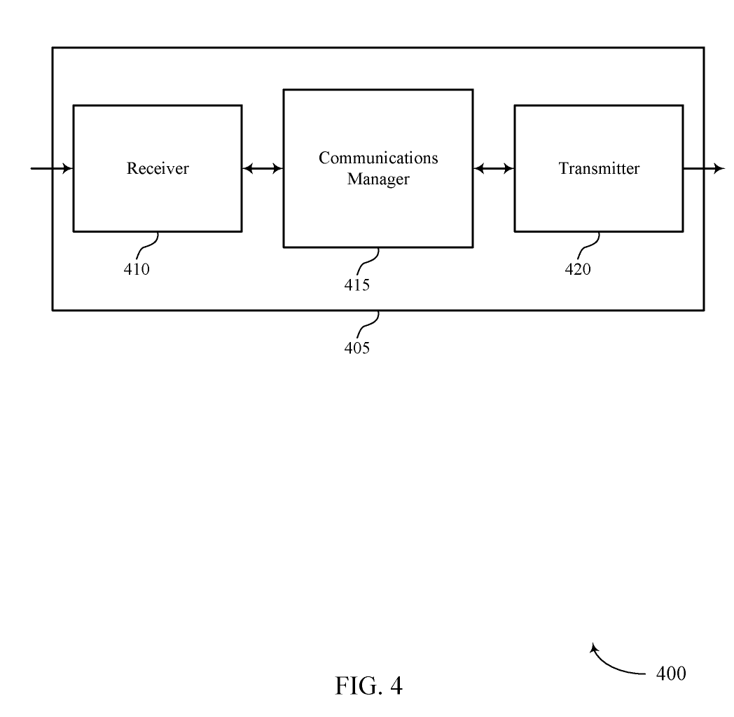

FIG. 4 shows a block diagram 400 of a wireless device 405 that supports bandwidth aggregation for WLAN systems in accordance with various aspects of the present disclosure. Wireless device 405 may be an example of aspects of a STA 115 or an AP 105 as described with reference to FIGS. 1 and 2. Wireless device 405 may include receiver 410, communications manager 415, and transmitter 420. Wireless device 405 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

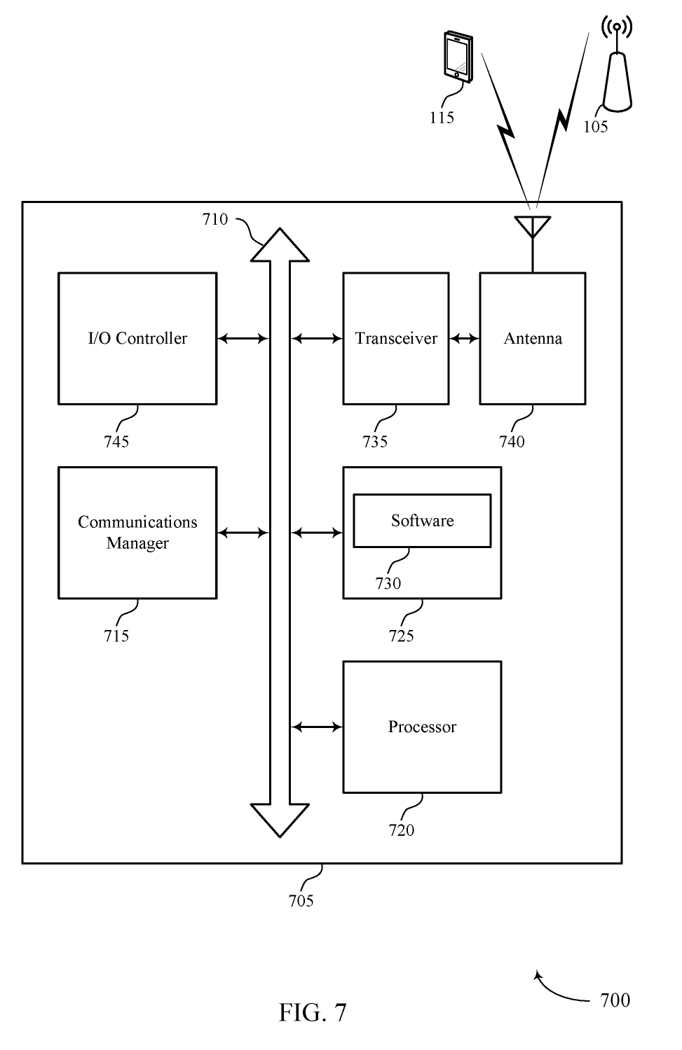

Receiver 410 may receive information such as packets, user data, or control information associated with various information channels (e.g., control channels, data channels, and information related to bandwidth aggregation for WLAN systems, etc.). Information may be passed on to other components of the device. The receiver 410 may be an example of aspects of the transceiver 735 described with reference to FIG. 7.

Communications manager 415 may be an example of aspects of the communications manager 715 described with reference to FIG. 7. Communications manager 415 and/or at least some of its various sub-components may be implemented in hardware, software executed by a processor, firmware, or any combination thereof. If implemented in software executed by a processor, the functions of the communications manager 415 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 415 and/or at least some of its various sub-components may be physically located at various positions, including being distributed such that portions of functions are implemented at different physical locations by one or more physical devices. In some examples, communications manager 415 and/or at least some of its various sub-components may be a separate and distinct component in accordance with various aspects of the present disclosure. In other examples, communications manager 415 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 415 may monitor a set of anchor channels of at least one RF spectrum band, receive, from a wireless device on a first anchor channel of the monitored plurality of anchor channels, a bandwidth aggregation indication for the wireless device 405, and identify, based at least in part on the received bandwidth aggregation indication, a bandwidth aggregation configuration for the wireless device 405, the bandwidth aggregation configuration including a first portion of the at least one RF spectrum band and a second portion of the at least one RF spectrum band for the apparatus to use to receive communications from the wireless device, the first portion of the at least one RF spectrum band being discontiguous in frequency with the second portion of the at least one RF spectrum band.

Transmitter 420 may transmit signals generated by other components of the device. In some examples, the transmitter 420 may be collocated with a receiver 410 in a transceiver module. For example, the transmitter 420 may be an example of aspects of the transceiver 735 described with reference to FIG. 7. The transmitter 420 may include a single antenna, or it may include a set of antennas.

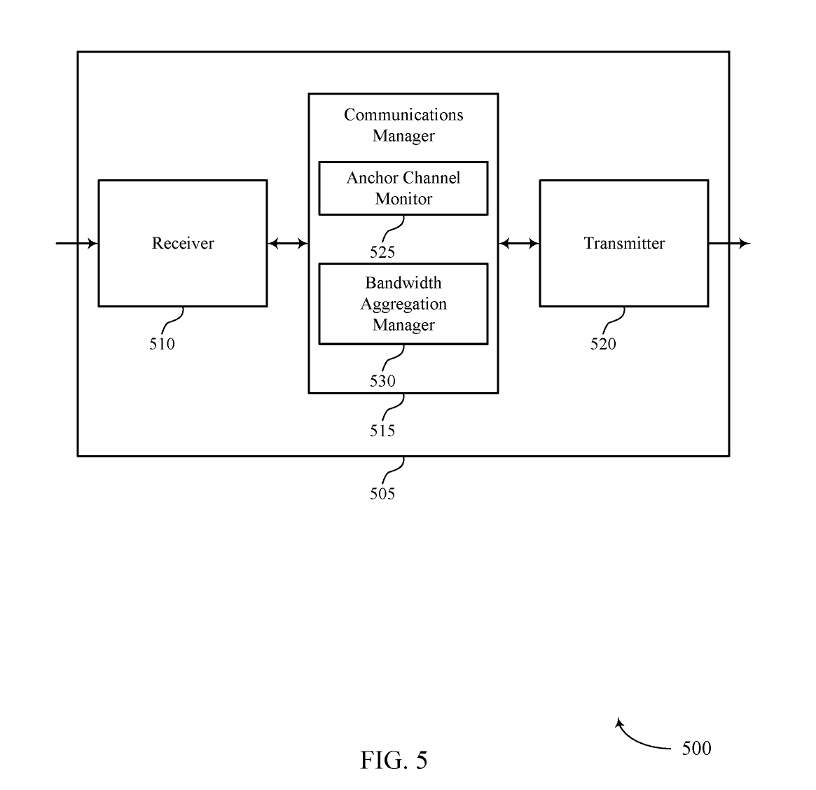

FIG. 5 shows a block diagram 500 of a wireless device 505 that supports bandwidth aggregation for WLAN systems in accordance with various aspects of the present disclosure. Wireless device 505 may be an example of aspects of a wireless device 405, an AP 105, or a STA 115 as described with reference to FIGS. 1, 2, and 4. Wireless device 505 may include receiver 510, communications manager 515, and transmitter 520. Wireless device 505 may also include a processor. Each of these components may be in communication with one another (e.g., via one or more buses).

Receiver 510 may receive information such as packets, user data, or control information associated with various information channels (e.g., control channels, data channels, and information related to bandwidth aggregation for WLAN systems, etc.). Information may be passed on to other components of the device. The receiver 510 may be an example of aspects of the transceiver 735 described with reference to FIG. 7.

Communications manager 515 may be an example of aspects of the communications manager 715 described with reference to FIG. 7. Communications manager 515 may also include anchor channel monitor 525 and bandwidth aggregation manager 530. In some examples, the communications manager 515 may be a processor (e.g., a transceiver processor, a radio processor, a transmitter processor, etc.). The processor may be coupled with memory and execute instructions in the memory that enable the processor to perform or facilitate the bandwidth aggregation features discussed herein. A transceiver processor may be collocated with and/or communicate with (e.g., direct the operations of) a transceiver of the device. A radio processor may be collocated with and/or communicate with (e.g., direct the operations of) one or more radios (e.g., one or more of an LTE radio, a Wi-Fi radio, or a combination of these) of the device. A transmitter processor may be collocated with and/or communicate with (e.g., direct the operations of) a transmitter of the device. The radio processor may direct the operations of two or more radios, where a first of the radios transmits in a first channel, including an anchor channel identifying the first channel and a second channel, and a second of the radios transmits in the second channel, for example as described according to one or more of the channel aggregation schemes described herein, including with reference to FIG. 3.

Anchor channel monitor 525 may monitor a set of anchor channels of at least one RF spectrum band. Anchor channel monitor 525 may receive, from a wireless device, a bandwidth aggregation indication for wireless device 505 on an anchor channel of the monitored set of anchor channels. Anchor channel monitor 525 may receive, on the anchor channel, an indication of an anchor channel configuration that identifies the set of anchor channels of the at least one RF spectrum band. Anchor channel monitor 525 may receive the bandwidth aggregation indication in a WLAN control frame or a preamble of a WLAN data frame. Anchor channel monitor 525 may monitor the first anchor channel of the set of anchor channels, the first anchor channel controlling channel access for a first set of channels of the at least one RF spectrum band. Anchor channel monitor 525 may monitor a second anchor channel of the set of anchor channels, the second anchor channel controlling channel access for a second set of channels of the at least one RF spectrum band, wherein at least one of the first set of channels is a same channel as at least one of the second set of channels. In some cases, the anchor channel is outside the first portion of the RF spectrum band and the second portion of the at least one RF spectrum band. In some cases, the set of anchor channels are evenly distributed in the at least one RF spectrum band. In some examples, the processor and/or memory may implement some or all of the operations of the anchor channel monitor 525. In some cases, the anchor channel monitor 525 may be a processor (e.g., a transceiver processor, or a radio processor, or a transmitter processor). The processor may be coupled with memory and execute instructions stored in the memory that enable the processor to perform or facilitate the anchor channel monitoring features discussed herein.

Bandwidth aggregation manager 530 may identify, based on the received bandwidth aggregation indication, a bandwidth aggregation configuration for the station, the bandwidth aggregation configuration including a first portion of the at least one RF spectrum band and a second portion of the at least one RF spectrum band for the wireless device 505 to use to receive data from the other wireless device, the first portion of the at least one RF spectrum band discontiguous in frequency with the second portion of the at least one RF spectrum band. In some cases, the first portion of the at least one RF spectrum band is separated in frequency from the second portion of the at least one RF spectrum band by less than 160 MHz. In some cases, the at least one RF spectrum band comprises a first RF spectrum band and a second RF spectrum band, the first anchor channel is in the first RF spectrum band, and a second anchor channel of the plurality of anchor channels is in the second RF spectrum band. In some cases, the bandwidth aggregation manager 530 may be a processor (e.g., a transceiver processor, or a radio processor, or a transmitter processor). The processor may be coupled with memory and execute instructions stored in the memory that enable the processor to perform or facilitate the bandwidth aggregation features discussed herein.

Transmitter 520 may transmit signals generated by other components of the device. In some examples, the transmitter 520 may be collocated with a receiver 510 in a transceiver module. For example, the transmitter 520 may be an example of aspects of the transceiver 735 described with reference to FIG. 7. The transmitter 520 may include a single antenna, or it may include a set of antennas.

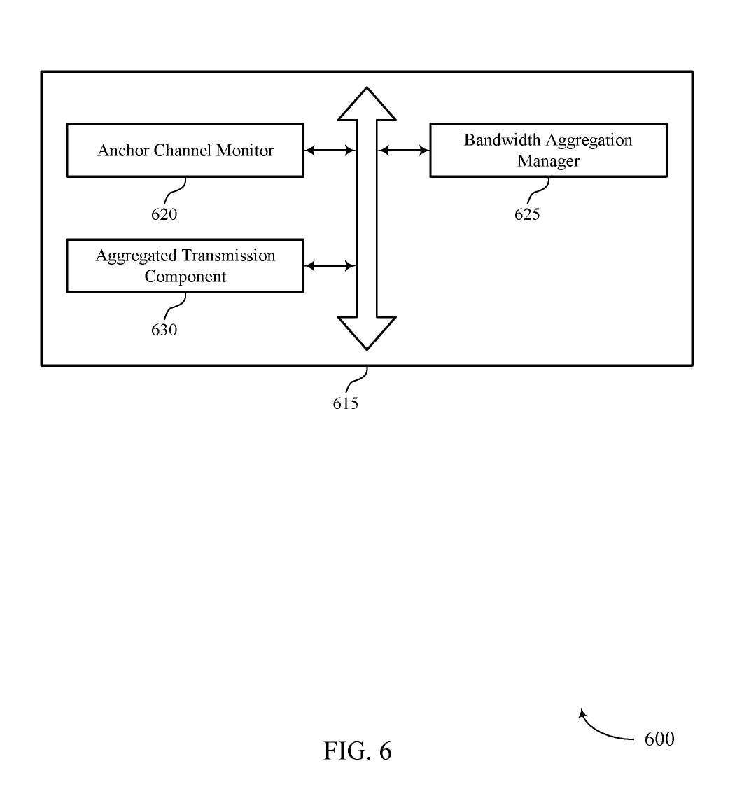

FIG. 6 shows a block diagram 600 of a communications manager 615 that supports bandwidth aggregation for WLAN systems in accordance with various aspects of the present disclosure. The communications manager 615 may be an example of aspects of a communications manager 415, a communications manager 515, or a communications manager 715 described with reference to FIGS. 4, 5, and 7. The communications manager 615 may include anchor channel monitor 620, bandwidth aggregation manager 625, and aggregated transmission component 630. Each of these modules may communicate, directly or indirectly, with one another (e.g., via one or more buses).

Anchor channel monitor 620 may monitor a set of anchor channels of at least one RF spectrum band. Anchor channel monitor 620 may receive, from a wireless device, a bandwidth aggregation indication for a device on an anchor channel of the monitored set of anchor channels. Anchor channel monitor 620 may receive, on the anchor channel, an indication of an anchor channel configuration that identifies the set of anchor channels of the at least one RF spectrum band. Anchor channel monitor 620 may receive the bandwidth aggregation indication in a WLAN control frame or a preamble of a WLAN data frame. Anchor channel monitor 620 may monitor the first anchor channel of the set of anchor channels, the first anchor channel controlling channel access for a first set of channels of the at least one RF spectrum band. Anchor channel monitor 620 may monitor a second anchor channel of the set of anchor channels, the second anchor channel controlling channel access for a second set of channels of the at least one RF spectrum band, wherein at least one of the first set of channels is a same channel as at least one of the second set of channels. In some cases, the anchor channel is outside the first portion of the RF spectrum band and the second portion of the at least one RF spectrum band. In some cases, the set of anchor channels are evenly distributed in the at least one RF spectrum band. In some cases, the anchor channel monitor 620 may be a processor (e.g., a transceiver processor, or a radio processor, or a transmitter processor). The processor may be coupled with memory and execute instructions stored in the memory that enable the processor to perform or facilitate the anchor channel monitoring features discussed herein.

Bandwidth aggregation manager 625 may identify, based on the received bandwidth aggregation indication, a bandwidth aggregation configuration for the station, the bandwidth aggregation configuration including a first portion of the at least one RF spectrum band and a second portion of the at least one RF spectrum band for the device to use to receive data from the other wireless device, the first portion of the at least one RF spectrum band discontiguous in frequency with the second portion of the at least one RF spectrum band. In some cases, the first portion of the at least one RF spectrum band is separated in frequency from the second portion of the at least one RF spectrum band by less than 160 MHz. In some cases, the at least one RF spectrum band comprises a first RF spectrum band and a second RF spectrum band, the first anchor channel is in the first RF spectrum band, and a second anchor channel of the plurality of anchor channels is in the second RF spectrum band. In some cases, the bandwidth aggregation manager 625 may be a processor (e.g., a transceiver processor, or a radio processor, or a transmitter processor). The processor may be coupled with memory and execute instructions stored in the memory that enable the processor to perform or facilitate the bandwidth aggregation features discussed herein.

Aggregated transmission component 630 may receive a first portion of the communications on the first portion of the at least one RF spectrum band and a second portion of the communications on the second portion of the at least one RF spectrum band based on the identified bandwidth aggregation configuration, both the first portion of the communications and the second portion of the communications received starting at a first time and ending at a second time. Aggregated transmission component 630 may receive a first portion of the communications from a first radio of another wireless device on the first portion of the at least one RF spectrum band and receive a second portion of the communications from a second radio of the other device on the second portion of the at least one RF spectrum band. Aggregated transmission component 630 may receive a first portion of the communications on the first portion of the at least one RF spectrum band and a second portion of the communications on the second portion of the at least one RF spectrum band based on the identified bandwidth aggregation configuration, the first portion of the communications received at least partially concurrently with the second portion of the communications. In some cases, the aggregated transmission component 630 may be a processor (e.g., a transceiver processor, or a radio processor, or a transmitter processor). The processor may be coupled with memory and execute instructions stored in the memory that enable the processor to perform or facilitate the bandwidth aggregation features discussed herein.

FIG. 7 shows a diagram of a system 700 including a device 705 that supports bandwidth aggregation for WLAN systems in accordance with various aspects of the present disclosure. Device 705 may be an example of or include the components of wireless device 405, wireless device 505, an AP 105, or a STA 115 as described above, e.g., with reference to FIGS. 1, 2, 4 and 5. Device 705 may include components for bi-directional voice and data communications including components for transmitting and receiving communications, including communications manager 715, processor 720, memory 725, software 730, transceiver 735, antenna 740, and I/O controller 745. These components may be in electronic communication via one or more busses (e.g., bus 710).

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting bandwidth aggregation for WLAN systems).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware and/or software operation such as the interaction with peripheral components or devices.

Software 730 may include code to implement aspects of the present disclosure, including code to support bandwidth aggregation for WLAN systems. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 745 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system. In other cases, I/O controller 745 may represent or interact with a modem, a keyboard, a mouse, a touchscreen, or a similar device. In some cases, I/O controller 745 may be implemented as part of a processor. In some cases, a user may interact with device 705 via I/O controller 745 or via hardware components controlled by I/O controller 745.

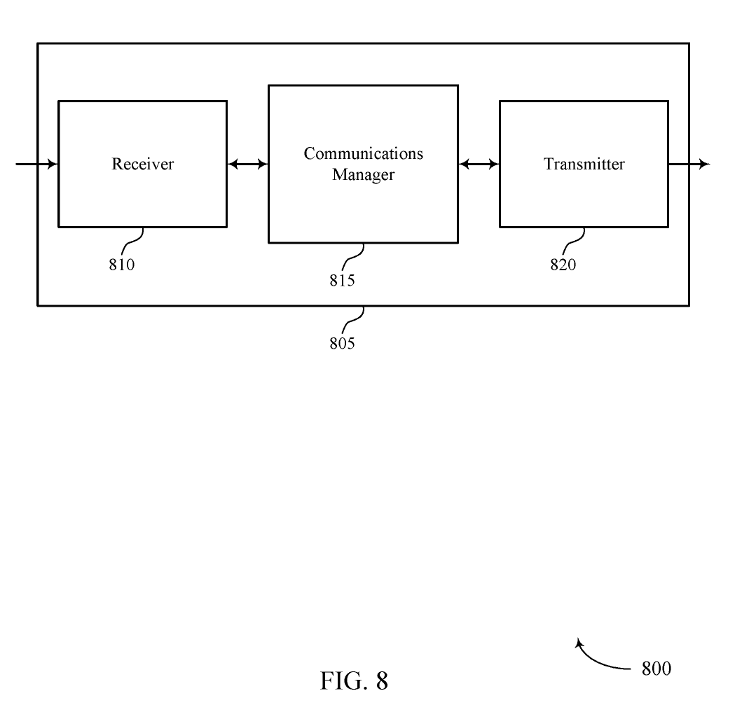

FIG. 8 shows a block diagram 800 of a wireless device 805 that supports bandwidth aggregation for WLAN systems in accordance with various aspects of the present disclosure. Wireless device 805 may be an example of aspects of an AP 105 or a STA 115 as described with reference to FIGS. 1 and 2. Wireless device 805 may include receiver 810, communications manager 815, and transmitter 820. Wireless device 805 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

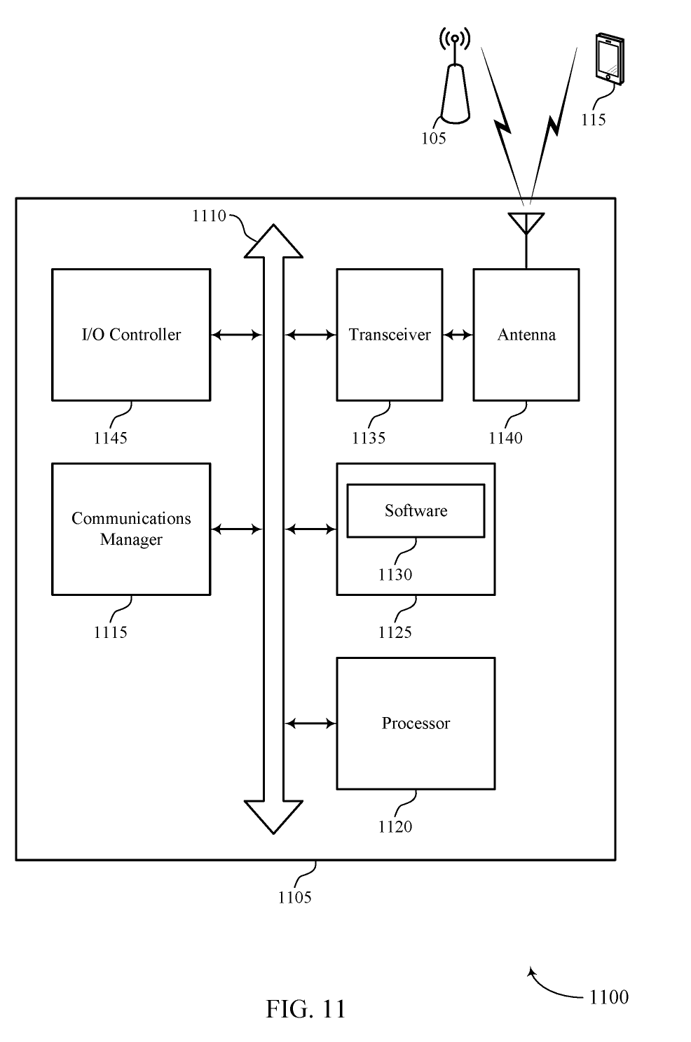

Receiver 810 may receive information such as packets, user data, or control information associated with various information channels (e.g., control channels, data channels, and information related to bandwidth aggregation for WLAN systems, etc.). Information may be passed on to other components of the device. The receiver 810 may be an example of aspects of the transceiver 1135 described with reference to FIG. 11.

Communications manager 815 may be an example of aspects of the communications manager 1115 described with reference to FIG. 11. Communications manager 815 and/or at least some of its various sub-components may be implemented in hardware, software executed by a processor, firmware, or any combination thereof. If implemented in software executed by a processor, the functions of the communications manager 815 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 815 and/or at least some of its various sub-components may be physically located at various positions, including being distributed such that portions of functions are implemented at different physical locations by one or more physical devices. In some examples, communications manager 815 and/or at least some of its various sub-components may be a separate and distinct component in accordance with various aspects of the present disclosure. In other examples, communications manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 815 may select a first anchor channel of a plurality of anchor channels of at least one RF spectrum band. Communications manager 815 may transmit, to a wireless device on the selected first anchor channel, a bandwidth aggregation indication for the wireless device. Communications manager 815 may transmit, to the wireless device, a first portion of communications on a first portion of the at least one RF spectrum band identified by the bandwidth aggregation indication. Communications manager 815 may transmit, to the wireless device, a second portion of the communications on a second portion of the at least one RF spectrum band identified by the bandwidth aggregation indication, the first portion of the RF spectrum band being discontiguous in frequency with the second portion of the RF spectrum band.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may include a single antenna, or it may include a set of antennas.

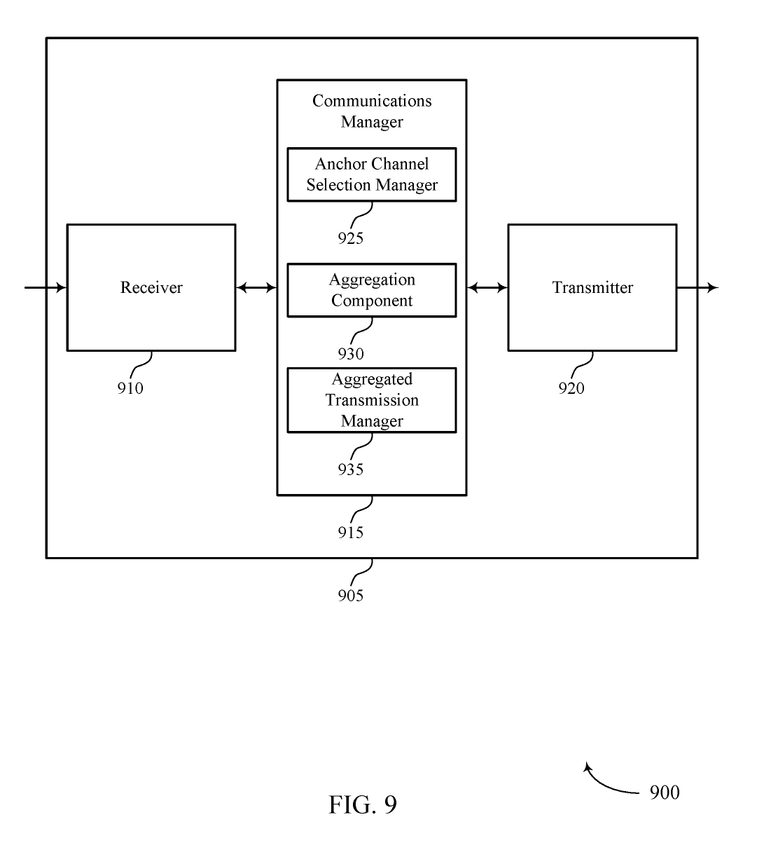

FIG. 9 shows a block diagram 900 of a wireless device 905 that supports bandwidth aggregation for WLAN systems in accordance with various aspects of the present disclosure. Wireless device 905 may be an example of aspects of a wireless device 805, a STA 115, or an AP 105 as described with reference to FIGS. 1, 2, and 8. Wireless device 905 may include receiver 910, communications manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to bandwidth aggregation for WLAN systems, etc.). Information may be passed on to other components of the device. The receiver 910 may be an example of aspects of the transceiver 1135 described with reference to FIG. 11.

Communications manager 915 may be an example of aspects of the communications manager 1115 described with reference to FIG. 11. Communications manager 915 may also include anchor channel selection manager 925, aggregation component 930, and aggregated transmission manager 935. In some examples, the communications manager 915 may be a processor (e.g., a transceiver processor, or a radio processor, or a receiver processor). The processor may be coupled with memory and execute instructions stored in the memory that enable the processor to perform or facilitate the bandwidth aggregation features discussed herein. A transceiver processor may be collocated with and/or communicate with (e.g., direct the operations of) a transceiver of the device. A radio processor may be collocated with and/or communicate with (e.g., direct the operations of) a radio (e.g., an LTE radio or a Wi-Fi radio) of the device. A receiver processor may be collocated with and/or communicate with (e.g., direct the operations of) a receiver of the device.

Anchor channel selection manager 925 may select a first anchor channel of a set of anchor channels of at least one RF spectrum band. In some cases, the anchor channel selection manager 925 may be a processor (e.g., a transceiver processor, or a radio processor, or a receiver processor). The processor may be coupled with memory and execute instructions stored in the memory that enable the processor to perform or facilitate the anchor channel selection features discussed herein.

Aggregation component 930 may transmit, to another device on the first anchor channel, a bandwidth aggregation indication for the other device and select the first portion and the second portion of the at least one RF spectrum band to use to transmit the communications based on the determination. In some cases, the aggregation component 930 may be a processor (e.g., a transceiver processor, or a radio processor, or a receiver processor). The processor may be coupled with memory and execute instructions stored in the memory that enable the processor to perform or facilitate the bandwidth aggregation features discussed herein.

Aggregated transmission manager 935 may transmit, to the other device, a first portion of the communications on a first portion of the at least one RF spectrum band identified by the bandwidth aggregation indication and transmit, to the other device, a second portion of the communications on a second portion of the at least one RF spectrum band identified by the bandwidth aggregation indication, the first portion of the at least one RF spectrum band discontiguous in frequency with the second portion of the at least one RF spectrum band. In some cases, the aggregated transmission manager 935 may be a processor (e.g., a transceiver processor, or a radio processor, or a receiver processor). The processor may be coupled with memory and execute instructions stored in the memory that enable the processor to perform or facilitate the bandwidth aggregation features discussed herein.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may include a single antenna, or it may include a set of antennas.

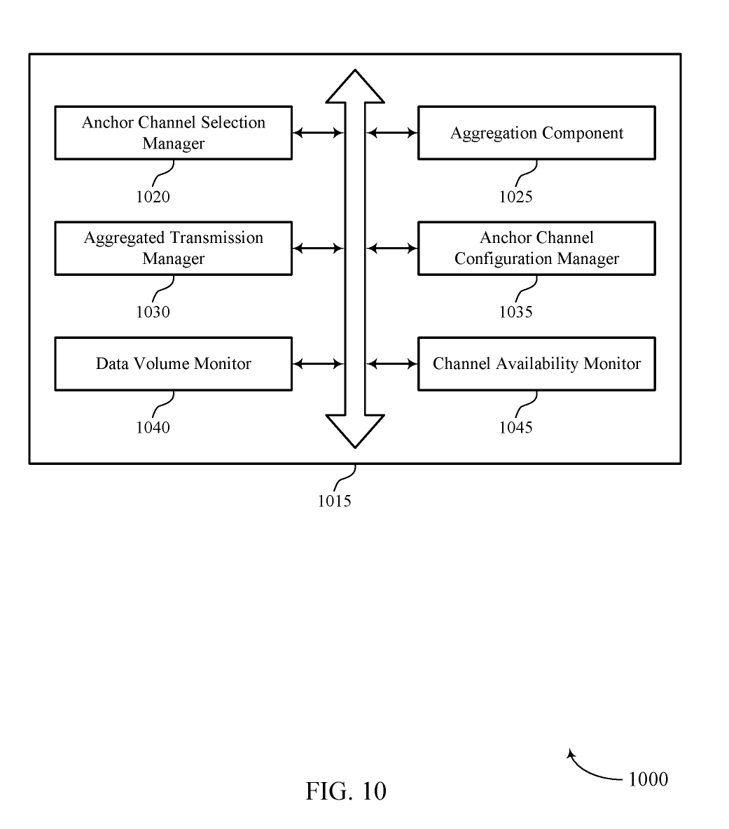

FIG. 10 shows a block diagram 1000 of an AP communications manager 1015 that supports bandwidth aggregation for WLAN systems in accordance with various aspects of the present disclosure. The AP communications manager 1015 may be an example of aspects of an AP communications manager 1115 described with reference to FIGS. 8, 9, and 11. The AP communications manager 1015 may include anchor channel selection manager 1020, aggregation component 1025, aggregated transmission manager 1030, anchor channel configuration manager 1035, data volume monitor 1040, and channel availability monitor 1045. Each of these modules may communicate, directly or indirectly, with one another (e.g., via one or more buses).

Anchor channel selection manager 1020 may select a first anchor channel of a set of anchor channels of at least one RF spectrum band. In some cases, the anchor channel selection manager 1020 may be a processor (e.g., a transceiver processor, or a radio processor, or a receiver processor). The processor may be coupled with memory and execute instructions stored in the memory that enable the processor to perform or facilitate the anchor channel selection features discussed herein.

Aggregation component 1025 may transmit, to another device on the first anchor channel, a bandwidth aggregation indication for the other device and select the first portion and the second portion of the at least one RF spectrum band to use to transmit the communications based on the determination. In some cases, the aggregation component 1025 may be a processor (e.g., a transceiver processor, or a radio processor, or a receiver processor). The processor may be coupled with memory and execute instructions stored in the memory that enable the processor to perform or facilitate the bandwidth aggregation features discussed herein.

Aggregated transmission manager 1030 may transmit, to the other device, a first portion of the communications on a first portion of the at least one RF spectrum band identified by the bandwidth aggregation indication and transmit, to the other device, a second portion of the communications on a second portion of the at least one RF spectrum band identified by the bandwidth aggregation indication, the first portion of the at least one RF spectrum band discontiguous in frequency with the second portion of the at least one RF spectrum band. In some cases, the aggregated transmission manager 1030 may be a processor (e.g., a transceiver processor, or a radio processor, or a receiver processor). The processor may be coupled with memory and execute instructions stored in the memory that enable the processor to perform or facilitate the bandwidth aggregation features discussed herein.

Anchor channel configuration manager 1035 may transmit, on the first anchor channel, an indication of an anchor channel configuration that identifies the set of anchor channels of the at least one RF spectrum band. In some cases, the anchor channel configuration manager 1035 may be a processor (e.g., a transceiver processor, or a radio processor, or a receiver processor). The processor may be coupled with memory and execute instructions stored in the memory that enable the processor to perform or facilitate the anchor channel configuration features discussed herein.

Data volume monitor 1040 may determine an amount of the communications to be transmitted to the other device. In some cases, the data volume monitor 1040 may be a processor (e.g., a transceiver processor, or a radio processor, or a receiver processor). The processor may be coupled with memory and execute instructions stored in the memory that enable the processor to perform or facilitate the bandwidth aggregation features discussed herein.

Channel availability monitor 1045 may determine a channel availability associated with the at least one RF spectrum band. Channel availability monitor 1045 may perform a first CCA for a second anchor channel of the plurality of anchor channels, wherein the CCA indicates that the second anchor channel is occupied. Channel availability monitor 1045 may perform a second CCA for the first anchor channel, wherein the second CCA indicates that the first anchor channel is unoccupied. Channel availability monitor 1045 may select the first portion and the second portion of the at least one RF spectrum band to use to transmit the communications based at least in part on the second CCA indicating that the first anchor channel is unoccupied. Channel availability monitor 1045 may perform, based at least in part on the second CCA indicating that the first anchor channel is unoccupied, a third CCA for at least one secondary channel associated with the first anchor channel, the second anchor channel, or both (e.g., where the first and second portions of the at least one RF spectrum band may be selected based at least in part on the third CCA. In some cases, the channel availability monitor 1045 may be a processor (e.g., a transceiver processor, or a radio processor, or a receiver processor). The processor may be coupled with memory and execute instructions stored in the memory that enable the processor to perform or facilitate the bandwidth aggregation features discussed herein.

FIG. 11 shows a diagram of a system 1100 including a device 1105 that supports bandwidth aggregation for WLAN systems in accordance with various aspects of the present disclosure. Device 1105 may be an example of or include the components of AP 105 or a STA 115 as described above, e.g., with reference to FIGS. 1 and 2. Device 1105 may include components for bi-directional voice and data communications including components for transmitting and receiving communications, including communications manager 1115, processor 1120, memory 1125, software 1130, transceiver 1135, antenna 1140, and I/O controller 1145. These components may be in electronic communication via one or more busses (e.g., bus 1110).

Processor 1120 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting bandwidth aggregation for WLAN systems).

Memory 1125 may include RAM and ROM. The memory 1125 may store computer-readable, computer-executable software 1130 including instructions that, when executed, cause the processor to perform various functions described herein. In some cases, the memory 1125 may contain, among other things, a BIOS which may control basic hardware and/or software operation such as the interaction with peripheral components or devices.

Software 1130 may include code to implement aspects of the present disclosure, including code to support bandwidth aggregation for WLAN systems. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system. In other cases, I/O controller 1145 may represent or interact with a modem, a keyboard, a mouse, a touchscreen, or a similar device. In some cases, I/O controller 1145 may be implemented as part of a processor. In some cases, a user may interact with device 1105 via I/O controller 1145 or via hardware components controlled by I/O controller 1145.

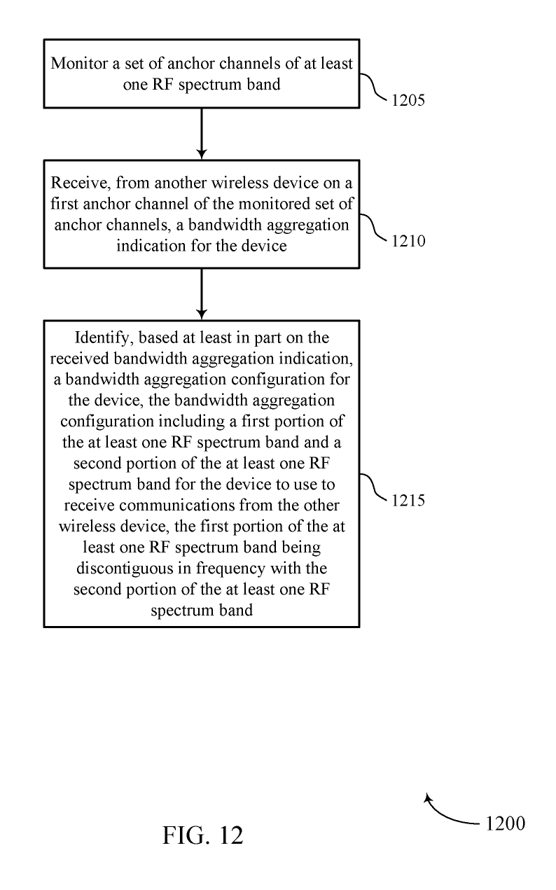

FIG. 12 shows a flowchart illustrating a method 1200 for bandwidth aggregation for WLAN systems in accordance with various aspects of the present disclosure. The operations of method 1200 may be implemented by a STA 115 or an AP 105 or its components as described herein. For example, the operations of method 1200 may be performed by a communications manager as described with reference to FIGS. 4 through 7. In some examples, a device may execute a set of codes to control the functional elements of the device to perform the functions described below. Additionally or alternatively, the device may perform aspects of the functions described below using special-purpose hardware.

At block 1205 the device may monitor a set of anchor channels of at least one RF spectrum band. The operations of block 1205 may be performed according to the methods described with reference to FIGS. 1 through 3. In certain examples, aspects of the operations of block 1205 may be performed by an anchor channel monitor as described with reference to FIGS. 4 through 7.

At block 1210 the device may receive, from another wireless device on a first anchor channel of the monitored set of anchor channels, a bandwidth aggregation indication for the device. The operations of block 1210 may be performed according to the methods described with reference to FIGS. 1 through 3. In certain examples, aspects of the operations of block 1210 may be performed by an anchor channel monitor as described with reference to FIGS. 4 through 7.

At block 1215 the device may identify, based at least in part on the received bandwidth aggregation indication, a bandwidth aggregation configuration for the device, the bandwidth aggregation configuration including a first portion of the at least one RF spectrum band and a second portion of the at least one RF spectrum band for the device to use to receive communications from the other wireless device, the first portion of the at least one RF spectrum band being discontiguous in frequency with the second portion of the at least one RF spectrum band. The operations of block 1215 may be performed according to the methods described with reference to FIGS. 1 through 3. In certain examples, aspects of the operations of block 1215 may be performed by a bandwidth aggregation manager as described with reference to FIGS. 4 through 7.

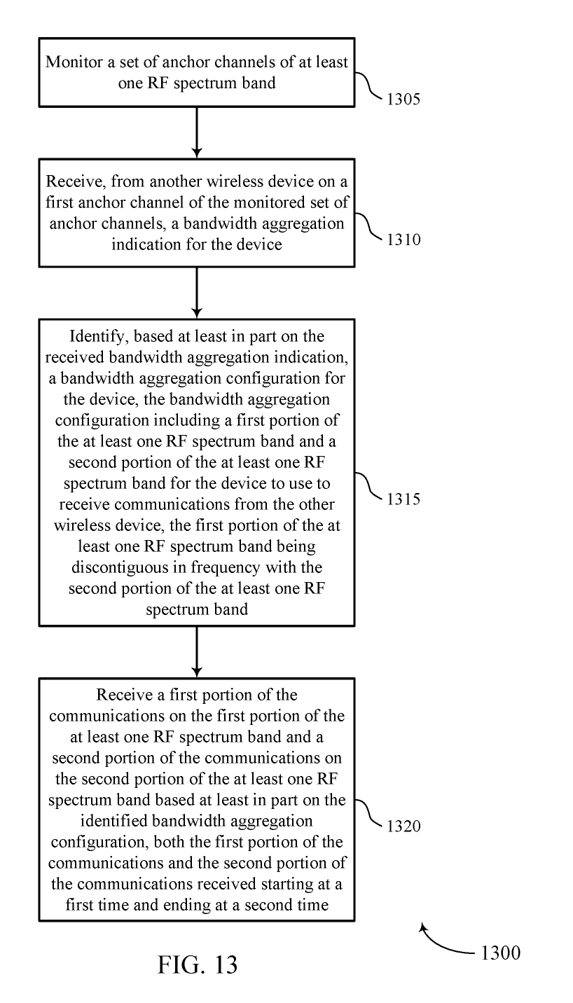

FIG. 13 shows a flowchart illustrating a method 1300 for bandwidth aggregation for WLAN systems in accordance with various aspects of the present disclosure. The operations of method 1300 may be implemented by a STA 115 or an AP 105 or its components as described herein. For example, the operations of method 1300 may be performed by a communications manager as described with reference to FIGS. 4 through 7. In some examples, a device may execute a set of codes to control the functional elements of the device to perform the functions described below. Additionally or alternatively, the device may perform aspects of the functions described below using special-purpose hardware.

At block 1305 the device may monitor a set of anchor channels of at least one RF spectrum band. The operations of block 1305 may be performed according to the methods described with reference to FIGS. 1 through 3. In certain examples, aspects of the operations of block 1305 may be performed by an anchor channel monitor as described with reference to FIGS. 4 through 7.

At block 1310 the device may receive, from another wireless device on a first anchor channel of the monitored set of anchor channels, a bandwidth aggregation indication for the device. The operations of block 1310 may be performed according to the methods described with reference to FIGS. 1 through 3. In certain examples, aspects of the operations of block 1310 may be performed by an anchor channel monitor as described with reference to FIGS. 4 through 7.

At block 1315 the device may identify, based at least in part on the received bandwidth aggregation indication, a bandwidth aggregation configuration for the device, the bandwidth aggregation configuration including a first portion of the at least one RF spectrum band and a second portion of the at least one RF spectrum band for the device to use to receive communications from the other wireless device, the first portion of the at least one RF spectrum band being discontiguous in frequency with the second portion of the at least one RF spectrum band. The operations of block 1315 may be performed according to the methods described with reference to FIGS. 1 through 3. In certain examples, aspects of the operations of block 1315 may be performed by a bandwidth aggregation manager as described with reference to FIGS. 4 through 7.

At block 1320 the device may receive a first portion of the communications on the first portion of the at least one RF spectrum band and a second portion of the communications on the second portion of the at least one RF spectrum band based at least in part on the identified bandwidth aggregation configuration, both the first portion of the communications and the second portion of the communications received starting at a first time and ending at a second time. The operations of block 1320 may be performed according to the methods described with reference to FIGS. 1 through 3. In certain examples, aspects of the operations of block 1320 may be performed by an aggregated transmission component as described with reference to FIGS. 4 through 7.

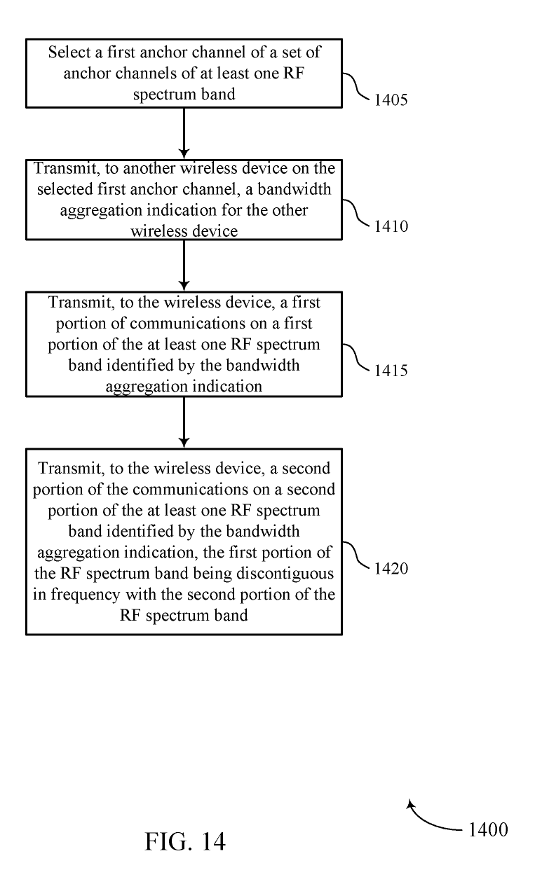

FIG. 14 shows a flowchart illustrating a method 1400 for bandwidth aggregation for WLAN systems in accordance with various aspects of the present disclosure. The operations of method 1400 may be implemented by an AP 105 or a STA 115 or its components as described herein. For example, the operations of method 1400 may be performed by a communications manager as described with reference to FIGS. 8 through 11. In some examples, a device may execute a set of codes to control the functional elements of the device to perform the functions described below. Additionally or alternatively, the device may perform aspects of the functions described below using special-purpose hardware.

At block 1405 the device may select a first anchor channel of a set of anchor channels of at least one RF spectrum band. The operations of block 1405 may be performed according to the methods described with reference to FIGS. 1 through 3. In certain examples, aspects of the operations of block 1405 may be performed by an anchor channel selection manager as described with reference to FIGS. 8 through 11.

At block 1410 the device may transmit, to another wireless device on the selected first anchor channel, a bandwidth aggregation indication for the other wireless device. The operations of block 1410 may be performed according to the methods described with reference to FIGS. 1 through 3. In certain examples, aspects of the operations of block 1410 may be performed by an aggregation component as described with reference to FIGS. 8 through 11.

At block 1415 the device may transmit, to the wireless device, a first portion of communications on a first portion of the at least one RF spectrum band identified by the bandwidth aggregation indication. The operations of block 1415 may be performed according to the methods described with reference to FIGS. 1 through 3. In certain examples, aspects of the operations of block 1415 may be performed by an aggregated transmission manager as described with reference to FIGS. 8 through 11.

At block 1420 the device may transmit, to the wireless device, a second portion of the communications on a second portion of the at least one RF spectrum band identified by the bandwidth aggregation indication, the first portion of the RF spectrum band being discontiguous in frequency with the second portion of the RF spectrum band. The operations of block 1420 may be performed according to the methods described with reference to FIGS. 1 through 3. In certain examples, aspects of the operations of block 1420 may be performed by an aggregated transmission manager as described with reference to FIGS. 8 through 11.

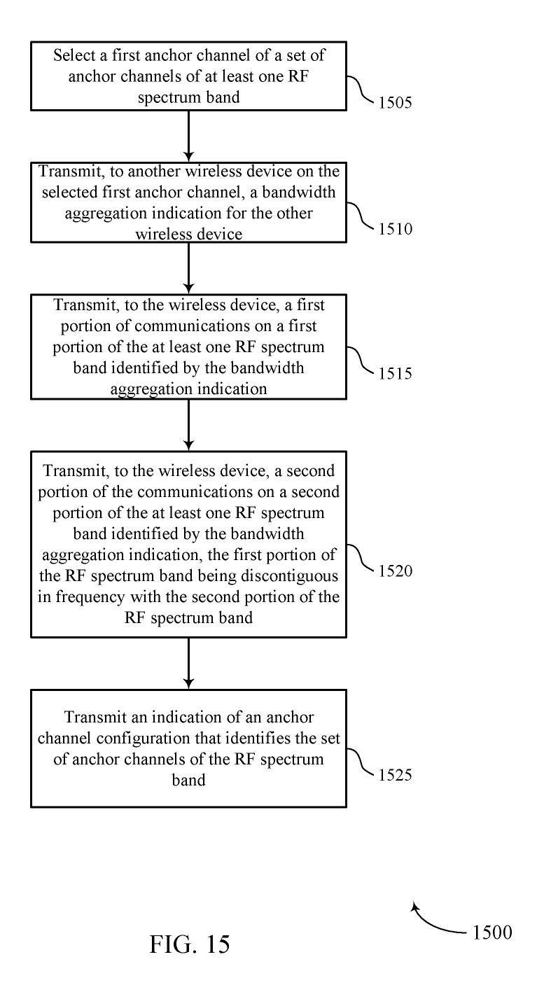

FIG. 15 shows a flowchart illustrating a method 1500 for bandwidth aggregation for WLAN systems in accordance with various aspects of the present disclosure. The operations of method 1500 may be implemented by an AP 105 or a STA 115 or its components as described herein. For example, the operations of method 1500 may be performed by a communications manager as described with reference to FIGS. 8 through 11. In some examples, a device may execute a set of codes to control the functional elements of the device to perform the functions described below. Additionally or alternatively, the device may perform aspects of the functions described below using special-purpose hardware.

At block 1505 the device may select a first anchor channel of a set of anchor channels of at least one RF spectrum band. The operations of block 1505 may be performed according to the methods described with reference to FIGS. 1 through 3. In certain examples, aspects of the operations of block 1505 may be performed by an anchor channel selection manager as described with reference to FIGS. 8 through 11.

At block 1510 the device may transmit, to another wireless device on the selected first anchor channel, a bandwidth aggregation indication for the other wireless device. The operations of block 1510 may be performed according to the methods described with reference to FIGS. 1 through 3. In certain examples, aspects of the operations of block 1510 may be performed by an aggregation component as described with reference to FIGS. 8 through 11.

At block 1515 the device may transmit, to the wireless device, a first portion of communications on a first portion of the at least one RF spectrum band identified by the bandwidth aggregation indication. The operations of block 1515 may be performed according to the methods described with reference to FIGS. 1 through 3. In certain examples, aspects of the operations of block 1515 may be performed by an aggregated transmission manager as described with reference to FIGS. 8 through 11.

At block 1520 the device may transmit, to the wireless device, a second portion of the communications on a second portion of the at least one RF spectrum band identified by the bandwidth aggregation indication, the first portion of the RF spectrum band being discontiguous in frequency with the second portion of the RF spectrum band. The operations of block 1520 may be performed according to the methods described with reference to FIGS. 1 through 3. In certain examples, aspects of the operations of block 1520 may be performed by an aggregated transmission manager as described with reference to FIGS. 8 through 11.

At block 1525 the device may transmit an indication of an anchor channel configuration that identifies the set of anchor channels of the RF spectrum band. The operations of block 1525 may be performed according to the methods described with reference to FIGS. 1 through 3. In certain examples, aspects of the operations of block 1525 may be performed by an anchor channel configuration manager as described with reference to FIGS. 8 through 11.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications (e.g., technology using licensed spectrum LTE protocols or versions of LTE protocols customized for use wholly or partially in the unlicensed spectrum).

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. An apparatus for wireless communication, comprising:
a processor;
memory in electronic communication with the processor; and
instructions stored in the memory and executable by the processor to cause the apparatus to:
monitor a plurality of anchor channels of at least one radio frequency (RF) spectrum band;
receive, from a wireless device on a first anchor channel of the monitored plurality of anchor channels, a bandwidth aggregation indication for the apparatus; and
identify, based at least in part on the received bandwidth aggregation indication, a bandwidth aggregation configuration for the apparatus, the bandwidth aggregation configuration including a first portion of the at least one RF spectrum band and a second portion of the at least one RF spectrum band for the apparatus to use to receive communications from the wireless device, the first portion of the at least one RF spectrum band being discontiguous in frequency with the second portion of the at least one RF spectrum band.

2. The apparatus of claim 1, wherein the instructions are further executable by the processor to cause the apparatus to:
receive a first portion of the communications on the first portion of the at least one RF spectrum band and a second portion of the communications on the second portion of the at least one RF spectrum band based at least in part on the identified bandwidth aggregation configuration, both the first portion of the communications and the second portion of the communications received starting at a first time and ending at a second time.

3. The apparatus of claim 1, wherein the instructions are further executable by the processor to cause the apparatus to:
receive, from an access point, an indication of an anchor channel configuration that identifies the plurality of anchor channels of the at least one RF spectrum band, wherein the access point is the wireless device or a second wireless device.

4. The apparatus of claim 1, wherein the instructions are further executable by the processor to cause the apparatus to:
transmit an indication of an anchor channel configuration that identifies the plurality of anchor channels of the at least one RF spectrum band.

5. The apparatus of claim 1, wherein the instructions are further executable by the processor to cause the apparatus to:
receive a first portion of the communications from a first radio of the wireless device on the first portion of the at least one RF spectrum band; and
receive a second portion of the communications from a second radio of the wireless device on the second portion of the at least one RF spectrum band.

6. The apparatus of claim 1, wherein the instructions are further executable by the processor to cause the apparatus to:
receive the bandwidth aggregation indication in a wireless local area networking (WLAN) control frame or a preamble of a WLAN data frame.

7. The apparatus of claim 1, wherein the first anchor channel is outside the first portion of the at least one RF spectrum band and the second portion of the at least one RF spectrum band.

8. The apparatus of claim 1, wherein the plurality of anchor channels are evenly distributed in the at least one RF spectrum band.

9. The apparatus of claim 1, wherein the first portion of the at least one RF spectrum band is separated in frequency from the second portion of the at least one RF spectrum band by less than 160 MHz.

10. The apparatus of claim 1, wherein the instructions are further executable by the processor to cause the apparatus to:
receive a first portion of the communications on the first portion of the at least one RF spectrum band and a second portion of the communications on the second portion of the at least one RF spectrum band based at least in part on the identified bandwidth aggregation configuration, the first portion of the communications received at least partially concurrently with the second portion of the communications.

11. The apparatus of claim 1, wherein the instructions executable by the processor to cause the apparatus to monitor the plurality of anchor channels further comprise instructions executable by the processor to cause the apparatus to:
monitor the first anchor channel of the plurality of anchor channels, the first anchor channel controlling channel access for a first set of channels of the at least one RF spectrum band; and
monitor a second anchor channel of the plurality of anchor channels, the second anchor channel controlling channel access for a second set of channels of the at least one RF spectrum band, wherein at least one of the first set of channels is a same channel as at least one of the second set of channels.

12. The apparatus of claim 1, wherein:
the at least one RF spectrum band comprises a first RF spectrum band and a second RF spectrum band;
the first anchor channel is in the first RF spectrum band; and
a second anchor channel of the plurality of anchor channels is in the second RF spectrum band.

13. An apparatus for wireless communication, comprising:
a processor;
memory in electronic communication with the processor; and
instructions stored in the memory and executable by the processor to cause the apparatus to:
select a first anchor channel of a plurality of anchor channels of at least one radio frequency (RF) spectrum band;
transmit, to a wireless device on the selected first anchor channel, a bandwidth aggregation indication for the wireless device;
transmit, to the wireless device, a first portion of communications on a first portion of the at least one RF spectrum band identified by the bandwidth aggregation indication; and
transmit, to the wireless device, a second portion of the communications on a second portion of the at least one RF spectrum band identified by the bandwidth aggregation indication, the first portion of the at least one RF spectrum band being discontiguous in frequency with the second portion of the at least one RF spectrum band.

14. The apparatus of claim 13, wherein the instructions are further executable by the processor to cause the apparatus to:
transmit an indication of an anchor channel configuration that identifies the plurality of anchor channels of the at least one RF spectrum band.

15. The apparatus of claim 13, wherein the instructions are further executable by the processor to cause the apparatus to:
receive, from an access point, an indication of an anchor channel configuration that identifies the plurality of anchor channels of the at least one RF spectrum band, wherein the access point is the wireless device or a second wireless device.

16. The apparatus of claim 13, wherein the instructions are further executable by the processor to cause the apparatus to:
determine an amount of the communications to be transmitted to the wireless device; and
select the first portion and the second portion of the at least one RF spectrum band to use to transmit the communications based at least in part on the determination.

17. The apparatus of claim 13, wherein the instructions are further executable by the processor to cause the apparatus to:
perform a first clear channel assessment (CCA) for a second anchor channel of the plurality of anchor channels, wherein the CCA indicates that the second anchor channel is occupied;
perform a second CCA for the first anchor channel, wherein the second CCA indicates that the first anchor channel is unoccupied; and
select the first portion and the second portion of the at least one RF spectrum band to use to transmit the communications based at least in part on the second CCA indicating that the first anchor channel is unoccupied.

18. The apparatus of claim 17, wherein the instructions are further executable by the processor to cause the apparatus to:
perform, based at least in part on the second CCA indicating that the first anchor channel is unoccupied, a third CCA for at least one secondary channel associated with the first anchor channel, the second anchor channel, or both.

19. A method for wireless communication at a first wireless device, comprising:
monitoring a plurality of anchor channels of at least one radio frequency (RF) spectrum band;
receiving, from a second wireless device on a first anchor channel of the monitored plurality of anchor channels, a bandwidth aggregation indication for the first wireless device; and
identifying, based at least in part on the received bandwidth aggregation indication, a bandwidth aggregation configuration for the first wireless device, the bandwidth aggregation configuration including a first portion of the at least one RF spectrum band and a second portion of the at least one RF spectrum band for the first wireless device to use to receive communications from the second wireless device, the first portion of the at least one RF spectrum band being discontiguous in frequency with the second portion of the at least one RF spectrum band.

20. The method of claim 19, further comprising:
receiving a first portion of the communications on the first portion of the at least one RF spectrum band and a second portion of the communications on the second portion of the at least one RF spectrum band based at least in part on the identified bandwidth aggregation configuration, both the first portion of the communications and the second portion of the communications received starting at a first time and ending at a second time.

21. The method of claim 19, further comprising:
receiving, from an access point, an indication of an anchor channel configuration that identifies the plurality of anchor channels of the at least one RF spectrum band, wherein the access point is the second wireless device or a third wireless device; or
transmitting the indication of the anchor channel configuration.

22. The method of claim 19, further comprising:
receiving a first portion of the communications from a first radio of the second wireless device on the first portion of the at least one RF spectrum band; and
receiving a second portion of the communications from a second radio of the second wireless device on the second portion of the at least one RF spectrum band.

23. The method of claim 19, further comprising:
receiving the bandwidth aggregation indication in a wireless local area networking (WLAN) control frame or a preamble of a WLAN data frame.

24. The method of claim 19, wherein the first anchor channel is outside the first portion of the at least one RF spectrum band and the second portion of the at least one RF spectrum band.

25. The method of claim 19, further comprising:
receiving a first portion of the communications on the first portion of the at least one RF spectrum band and a second portion of the communications on the second portion of the at least one RF spectrum band based at least in part on the identified bandwidth aggregation configuration, the first portion of the communications received at least partially concurrently with the second portion of the communications.

26. The method of claim 19, wherein monitoring the plurality of anchor channels comprises:
monitoring the first anchor channel of the plurality of anchor channels, the first anchor channel controlling channel access for a first set of channels of the at least one RF spectrum band; and
monitoring a second anchor channel of the plurality of anchor channels, the second anchor channel controlling channel access for a second set of channels of the at least one RF spectrum band, wherein at least one of the first set of channels is a same channel as at least one of the second set of channels.

27. A method for wireless communication at a first wireless device, comprising:
selecting a first anchor channel of a plurality of anchor channels of at least one radio frequency (RF) spectrum band;
transmitting, to a second wireless device on the selected first anchor channel, a bandwidth aggregation indication for the second wireless device;
transmitting, to the second wireless device, a first portion of communications on a first portion of the at least one RF spectrum band identified by the bandwidth aggregation indication; and
transmitting, to the second wireless device, a second portion of the communications on a second portion of the at least one RF spectrum band identified by the bandwidth aggregation indication, the first portion of the at least one RF spectrum band being discontiguous in frequency with the second portion of the at least one RF spectrum band.

28. The method of claim 27, further comprising:
transmitting an indication of an anchor channel configuration that identifies the plurality of anchor channels of the at least one RF spectrum band; or
receiving, from an access point, the indication of the anchor channel configuration, wherein the access point is the second wireless device or a third wireless device.

29. The method of claim 27, further comprising:
determining an amount of the communications to be transmitted to the second wireless device; and
selecting the first portion and the second portion of the at least one RF spectrum band to use to transmit the communications based at least in part on the determination.

30. The method of claim 27, further comprising:
performing a first clear channel assessment (CCA) for a second anchor channel of the plurality of anchor channels, wherein the CCA indicates that the second anchor channel is occupied;
performing a second CCA for the first anchor channel, wherein the second CCA indicates that the first anchor channel is unoccupied; and
selecting the first portion and the second portion of the at least one RF spectrum band to use to transmit the communications based at least in part on the second CCA indicating that the first anchor channel is unoccupied.
